(19) United States
(12) Patent Application Publication
(10) Pub. No.: US 2006/0184907 A1
(43) Pub. Date: Aug. 17, 2006

(54) Extracting/reflecting method and hierarchical circuit information with physical information and circuit designing method using the same

(76) Inventors: Shozo Hirano, Osaka-shi (JP); Masakazu Tanaka, Kyotanabe-shi (JP); Masanori Ito, Takatuki-shi (JP)

Correspondence Address: MCDERMOTT WILL & EMERY LLP, 600 13TH STREET, N.W., WASHINGTON, DC, 20005-3096, US

(21) Appl. No.: 11/315,594

(22) Filed: Dec. 23, 2005

(30) Foreign Application Priority Data
Dec. 24, 2004 (JP) P2004-374591

(51) Int. Cl. G06F 17/50

(52) U.S. Cl. 716/7

(57) ABSTRACT

By reflecting physical information extracted from layout information on hierarchical circuit information while maintaining its hierarchical structure and creating the hierarchical circuit information with the physical information, to reflect the physical information with its accuracy kept on the hierarchical circuit information, thereby realizing high speed of circuit simulation and reduction in a quantity of data. This invention includes a physical information extracting step of extracting, from layout information, information on a physical status i.e. physical information of a single unit e.g. each element or cell such as a shape parameter and a device performance/characteristic of a parasitic element, a parasitic coupling element or a device,; and a physical information reflecting step of reflecting the physical information extracted while maintaining its hierarchical structure on hierarchically organized circuit information

### BACKGROUND OF THE INVENTION

1. Field of the Invention

This invention relates to a physical information extracting/reflecting method for a semiconductor integrated circuit, and hierarchical circuit information with physical information and circuit designing method using the extracting/reflecting method.

2. Description of the Related Art

A large scale semiconductor integrated circuit (LSI) is a key device indispensable to an electric appliance. By making fine the size of mountable minimum transistors, the LSI has increased the number of circuits mountable in the LSI to realize sophisticated function.

As a technique for designing the LSI incorporating these large number of circuit elements and functional modules, a hierarchy designing method has been generally adopted. The hierarchy designing method is as follows. First, for each of small-scale modules, circuit design and layout design are executed individually. Next, the circuit design and layout design for functional modules which can be realized by combining the small-scale functional modules are executed. By combining these functional modules in a bottom-up manner, a large scale module is designed.

FIG. 38 is a structure diagram of circuit information and layout information designed by the hierarchy designing technique. The structure is expressed using functional modules (cells) such as a1, a2, a3, b1, b2 and d1. In this specification, modules each having a function are expressed as cells; examples of the modules are a monolithic element such as a MOSFET, BJT, resistor, capacitor and inductor; a functional element such as an inverter and NAND; and a functional block such as a PLL and adder.

Concretely, a cell d1 is composed of two cells b1 and a cell b2. Further, the cell b1 is composed of a cell a1 and a cell a2. The cell b2 is composed of the cell a1 and a cell a3. Level expresses the level of the hierarchy. Level 1 represents a top level and Level 2 represents in order a level below the top level by one level.

FIG. 39 is a structure diagram of the circuit information and layout information designed by the hierarchy designing technique. The structure is expressed by instances (0201 to 0220) such as x1, x2 and x3. The instance denotes the situation used in an upper level. Concretely, cell d1 (0101, 0111) is composed of instances x1, x2 and x3 (0202 to 0204, 0312 to 0214). Both instances) refer to cell b1 (0102, 0112, 0103, 0113). Instance x3 (0204, 0214) refers to cell b2 (0104, 0114).

Instances x1 (0202, 0212) and x2 (0202, 0213) have the same function and refer to the same cell so that the substantial quantity of data can be realized by ½. In this way, the hierarchy design handles the instances having the same function as the cell and adopts a structure referring to the cell, thereby realizing an efficient data structure.

Next, the hierarchy designing technique will be explained. First, as seen from FIG. 40, the circuit of cell a1 is designed. By the circuit design of cell a1, the model tp, gate terminal g, drain terminal d, source terminal s, transistor length l and transistor width w of a MOSFET transistor were designed. Next, as seen from FIG. 41, the layout of cell a1 is designed. FIG. 41(a) represents circuit information and FIG. 41(b) represents the layout information corresponding to the circuit information of FIG. 41(a). In order that the model tp, transistor length l and transistor width w are made, a transistor is constructed to have physical layers 0701 to 0706 such as a contact hole, a contact diffused region, a gate region, a source/drain region, a source/drain contact and an active region (region encircled by an element isolation region). Next, labels g, d and s are added to the positions corresponding to the terminals of the transistor. Thus, the layout of cell a1 is designed. Likewise, for cells a2 and cell a3, the circuit design and layout design will be executed individually. In this specification, cells a1, a2 and a3 in a minimum level (bottom level) are referred to as Level 3.

Next, as seen from FIG. 42, the circuit of cell b1 is designed. Cell b1 is an inverter element which can be composed of cell a1 and cell a2. The circuit of cell b1 was designed by adding the location of each of instances x1 referring to a1 and x2 referring to a2 and their connecting terminals a, y, vdd and vss. Likewise, the layout of cell b1 was designed by adding the location of each of instances x1 referring to a1 and x2 referring to a2 and their connecting terminals a, y, vdd and vss. In this specification, the second level to which cell b1 and cell b2 belong is referred to as Level 2. FIG. 42(a) and (b) is a view showing the circuit information and layout information of cell b1 in Level 2. Incidentally, FIGS. 43(a) and (b) is a view when cell b is seen flat. FIGS. 44(a) and (b) is a view showing the circuit information and layout information of cell b2 in Level 2. They can be designed in the same manner as cell b1.

Next, as seen from FIG. 45, cell d1 is designed. Its designing technique, which is the same as that for cell a1, b1, etc., will not be explained here. FIGS. 45(a) and (b) is a view showing the circuit information and layout information of cell d1, respectively. In this way, by the hierarchy designing technique, cell d1 was designed. Thus, as regards cell d1, its circuit information and layout information is organized in a hierarchical structure. In this specification, the hierarchical structure is successively divided into plural levels such as Level 1, Level 2 and Level 3. Cell d1 in the maximum level (top level) is referred to as Level 1.

FIG. 46 is a view showing the operation of circuit simulation. It is also referred to as a pre-layout simulation. In operation, hierarchical circuit information 0301 is inputted. By net list extraction processing 0302, a hierarchical net list 0303 is extracted. The net list is information in a text format constructed by connection information between elements, and the hierarchical net list is constructed of cells and instances (see FIGS. 38 and 39). With an input of the hierarchical net list, circuit simulation with no physical information 0304 is executed. U.S. Pat. No. 6,577,992B1 roposes a high speed simulation technique making full use of the feature of the hierarchical net list. In the simulation with no physical information with an input of the hierarchical net list, the operation in an ideal status can be verified. However, its accuracy is low because the physical information such as a parasitic element (layout parameter) or shape changes existing within the layout is not taken into consideration.

FIG. 47 is a view showing the operation of circuit simulation with high accuracy. It is also referred to as a post-layout simulation. In operation, hierarchical circuit information 0501 is inputted. Via a physical information extracting step 0502, physical information 0503 is obtained. As the physical information extracting step, various techniques such as LPE (Layout Parameter Extraction), DRC (Design Rule Check) and an optical simulation (ORC: Optical Rule Check) are previously known. Further, there are various kinds of physical information to be extracted. JP-A-10-135335 proposes a technique for checking a layout pattern, creating a net list representing a portion with a fear of latch-up as a latch-up element and suppressing the latch-up at a simulation step prior to a manufacturing process by circuit verification. The physical information extracting technique can be adopted according to the physical information to be extracted. However, in order to extract the physical information, any technique requires the layout to be flatten as shown FIG. 48. This is because the physical information is changed or determined by the condition of an environmental layout. Next, by net list extracting processing 0504, a net list with physical information 0505 is extracted. This net list with physical information is organized in a flat structure. With an input of the net list with physical information, simulation with physical information 0506 is executed. The simulation with physical information permits the circuit to be verified with high accuracy taking the physical information such as a layout parameter or shape changes existing within the layout into consideration. However, this simulation with physical information, which is “flat” processing, provides a problem of increasing a simulating time.

As described above, the simulation with no physical information permits the operation in an ideal status to be verified at a high speed, but provide a problem in accuracy in which the physical information such as a layout parameter or shape changes existing within the layout into consideration. On the other hand, the simulation with physical information permits the circuit to be verified with high accuracy taking the physical information such as a layout parameter or shape changes existing within the layout into consideration, but provides a problem of increasing a simulating time because it is flat processing. JP-A-10-143551 proposes a technique for feeding back the physical information to the circuit information. However, partial circuits are flat. So if the partial circuit for feedback are large, the processing time increases inevitably.

This invention has been accomplished in view of the above circumstance. An object of this invention is to reflect physical information with its accuracy kept on hierarchical circuit information by reflecting the physical information extracted from layout information on the hierarchical circuit information while maintaining its hierarchical structure and creating the hierarchical circuit information with the physical information, thereby realizing high speed of circuit simulation and reduction in a quantity of data.

To this end, this invention is characterized by comprising a physical information extracting step of extracting physical information from layout information; and a physical information reflecting step of reflecting the physical information extracted on hierarchically organized circuit information while maintaining its hierarchical structure, thereby providing the hierarchical circuit information with the physical information.

In this invention, the physical information refers to element information on a parasitic element, a parasitic coupling element, a device element, a cell, etc. and the information on the shape, performance, characteristic, physical status, etc of each element.

In this invention, the layout information is hierarchically organized layout information; and the physical information extracting step includes a step of extracting the physical information by flattering a lower level of a part or entirety of the hierarchically organized layout information.

In this invention, the layout information contains a layout portion corresponding to the hierarchically organized circuit information, which is not hierarchically organized.

In accordance with this configuration, the physical information for the corresponding layout can be reflected on the hierarchically organized circuit information while maintaining it hierarchical structure. For this reason, the quantity of data to be reflected can be reduced and the time of simulation on which the physical information is reflected can be shortened.

In this invention, the physical information extracting step includes a step of extracting the physical information having information on a level at issue and the component for each level.

In this invention, the physical information extracting step includes a step of extracting the physical information having information on a level at issue, connecting information between levels and the component for each level.

In this invention, the layout information is another semiconductor manufacturing process layout information based on the basis of another semiconductor manufacturing process different from a semiconductor manufacturing process at issue; and the physical information extracting step includes a post-processing step of extracting the physical information from another semiconductor manufacturing process layout information and correcting the physical information so that the physical information not changing according to semiconductor manufacturing processes is not corrected whereas the physical information changing according to the semiconductor manufacturing processes is corrected so as to be suited to the semiconductor manufacturing process at issue using difference information between another semiconductor manufacturing process and the semiconductor manufacturing process at issue.

In accordance with this configuration, if there is the layout information already designed by another semiconductor manufacturing process, using the difference information, the physical information extracted is corrected for reusing. For this reason, the time taken for extraction can be shortened. In addition, even if there is no layout for a target manufacturing process, the hierarchical circuit information with physical information can be obtained.

In this invention, the layout information is another semiconductor manufacturing process layout information on the basis of another semiconductor manufacturing process different from a semiconductor manufacturing process at issue; and the physical information extracting step includes a pre-processing step of correcting another semiconductor manufacturing process layout information into the layout information for the semiconductor manufacturing process at issue through process migration so that it is suited to the semiconductor manufacturing process at issue using difference information between the semiconductor manufacturing process at issue and another semiconductor manufacturing process.

In accordance with this configuration, quality improvement or area reduction of the layout can be realized through process migration. Further, using the difference information relative to the layout changed through the process migration, the physical information extracted is corrected for reusing. Thus, even if there is no layout of a target semiconductor manufacturing process, the hierarchical circuit information with physical information as well as the layout information of the target semiconductor manufacturing process can be obtained. In short, the number of man-hours and designing period can be reduced.

In this invention, the layout information is another layout information different from the layout information at issue; and the physical information extracting step includes a post-processing step of extracting the physical information from another layout information and correcting the physical information different from that for the layout information at issue so that it is suited to the layout information at issue using difference information between the layout information at issue and another layout information.

In accordance with this configuration, where the layout from which the physical information has been extracted has been modified, using the difference information on the layout modified, the physical information extracted is corrected for reusing. For this reason, the processing time taken for extracting the physical information can be reduced. In addition, even if there is no target layout, the circuit information with physical information can be obtained.

In this invention, the layout information is another layout information different from the layout information at issue; and the physical information extracting step includes a pre-processing step of correcting another layout information so that it is suited to the layout information at issue using difference information between the layout information at issue and another layout information.

In accordance with this configuration, where the layout from which the physical information has been extracted is modified, using the difference information on the layout modified, the physical information extracted is corrected for reusing. For this reason, even if there is no target layout, the circuit information with physical information can be obtained. Thus, the number of man-hours and designing period can be reduced.

In this invention, the physical information reflecting step includes a step of reflecting the physical information on an element included in the circuit information.

In this invention, the physical information reflecting step includes a step of adding another element to the circuit information.

In this invention, the physical information reflecting step includes a step of reflecting the physical information on the hierarchically organized circuit information using algebras.

In accordance with this configuration, by using the algebras for the common physical information, the time taken for extraction and quantity of data of the physical information extracted can be reduced.

In this invention, the physical information reflecting step includes a step of reflecting the physical information on the circuit information in different levels using algebras.

In this invention, the physical information reflecting step includes a step of reflecting the physical information on the hierarchically organized information by reflecting the physical information on net list creating information.

In this invention, the physical information reflecting step includes a step of reflecting the physical information on the hierarchically organized information by creating cells.

In accordance with this configuration, since the physical information corresponding to each of different layout portions can be reflected by creating cells, the time taken for extraction can be reduced.

This invention further comprises the step of manually or automatically selecting an optimum physical information reflecting step on the basis of control information for optimizing the processing time for circuit simulation.

In accordance with this configuration, the processing time of circuit simulation based on the reflection of the physical information can be reduced.

This invention further comprises the step of manually or automatically selecting an optimum physical information reflecting step on the basis of control information for optimizing the quantity of data.

In accordance with this configuration, the processing time of circuit simulation based on the reflection of the physical information can be reduced.

In this invention, the physical information reflecting step includes a step of reflecting at least two items of layout information corresponding to the circuit information in a single level on the circuit information in the single level.

In accordance with this configuration, the quantity of data of the physical information extracted/reflected can be reduced.

In this invention, the physical information reflecting step includes a step of reflecting the physical information extracted for a common layout portion from at least two items of layout information corresponding to the circuit information in a single level and the physical information extracted for the other portion than the common layout portion on the circuit information in the single level.

In accordance with this configuration, the quantity of data of the physical information for the common layout portion extracted/reflected can be reduced.

In this invention, the physical information reflecting step includes a step of setting a threshold value as control information for controlling unification, summarizing various items of physical information in the same physical information using the threshold value if they are not larger than or smaller than the threshold value and reflecting the same physical information on the hierarchically organized circuit information.

In accordance with this configuration, the quantity of data of the physical information for the common layout portion extracted and reflected can be reduced without lowering the accuracy so greatly according to the threshold value.

In this invention, the same physical information is summarized at an average value, a maximum value or a minimum value.

In this invention, the threshold value may be a ratio.

In this invention, the threshold value may be a numerical value.

In this invention, the threshold value may be evenly set for the circuit information and the physical information.

In this invention, the threshold value may be individually set for the circuit information, physical information or a combination thereof.

In accordance with this configuration, the quantity of data of the physical information for the common layout portion extracted/reflected can be reduced according to the requirement of accuracy for a target circuit.

In this invention, the threshold value may be individually set for the circuit information, physical information or a combination thereof on the basis of an evaluation equation previously set.

In this invention, the threshold value is set for each level, and which of an upper level and an lower level should be given priority is set individually or evenly.

In accordance with this configuration, the quantity of data of the physical information for the common layout portion extracted and reflected can be reduced without lowering the accuracy so greatly according to the level.

In this invention, the unification may be carried out using an optimum threshold value for optimizing the processing time of circuit simulation, which is manually or automatically selected.

In accordance with this configuration, the time for the circuit simulation based on the physical information extracted and reflected can be reduced.

In this invention, the unification may be carried out using an optimum threshold value for optimizing the quantity of data, which is manually or automatically selected.

In accordance with this configuration, the time taken for the circuit simulation based on the physical information extracted and reflected can be reduced.

In this invention, the unification may be carried out using an optimum threshold value for optimizing the accuracy of circuit simulation, which is manually or automatically selected.

In accordance with this configuration, the accuracy of the circuit simulation based on the physical information extracted and reflected can be maximized.

In this invention, the physical information reflecting step includes a step of saving the hierarchical circuit information after the physical information has been reflected thereon, with a different name from that before reflected.

In accordance with this configuration, the circuit information used for circuit verification and layout design and the circuit information on which the physical information has been reflected can be both saved and the correspondence therebetween can be clarified.

In this invention, the physical information reflecting step includes a step of saving the hierarchical circuit information after the physical information has been reflected thereon, with a different name from that before reflected and in relation to setting information and threshold information.

In this invention, the circuit information after reflected may be information used for circuit verification and the circuit information before reflected may be information used for layout.

In this invention, the physical information reflecting step is an individual level physical information reflecting step of reflecting the physical information having the component for each level on the hierarchical organized circuit information as a level parameter.

In accordance with this configuration, since the physical information is given for each level, the quantity of data of the physical information can be reduced.

In this invention, the individual level physical information reflecting step employs control information for controlling the number of levels.

In accordance with this configuration, the quantity of data of the physical information for the common layout portion extracted and reflected can be reduced taking necessary accuracy of the circuit simulation into consideration.

In this invention, the control information for controlling the number of levels contains the control information for each cell.

In this invention, the control information for controlling the number of levels contains the control information for each instance.

In this invention, the control information for controlling the number of levels contains the control information for each net.

In this invention, the control information for controlling the number of levels contains the control information for each physical information.

In this invention, the control information for controlling the number of levels contains the control information set on the basis of an evaluation equation.

In this invention, the each level physical information reflecting step employs control information for controlling the number of connecting points between a level at issue and another level.

In accordance with this configuration, the quantity of data of the physical information for the common layout portion extracted and reflected can be reduced according to the requirement of the accuracy of a target circuit by controlling the number of connecting points between the level at issue and another level.

The control information for controlling the number of connecting points between the levels contains the control information individually set according to the number of connecting points between a level at issue and another level.

In accordance with this configuration, the quantity of data of the physical information for the common layout portion extracted and reflected can be reduced according to the requirement of the accuracy of an individual target circuit by controlling the number of connecting points between the level at issue and another level.

In this invention, the control information for controlling the number of connoting points between levels contains the control information for each cell.

In this invention, the control information for controlling the number of connecting points between the level at issue and another level contains the control information for each instance.

In this invention, the control information for controlling the number of connecting points between the level at issue and another level contains the control information for each net.

In this invention, the control information for controlling the number of connecting points between the level and another level contains the control information for each physical information.

In this invention, the control information for controlling the number of connecting points between the level and another level contains the control information set on the basis of an evaluation equation.

In this invention, the physical information reflecting step includes a physical information changing step of changing another physical information according to the physical information at issue and reflecting the changed physical information on the circuit information.

In accordance with this configuration, since the physical information to be reflected can be reduced, the processing time taken for extraction/reflection can be reduced.

The physical information extracting/reflecting method according to this invention is characterized in that the circuit information with physical information is optimized using the control information for controlling the unification, control information for controlling the number of levels, or control information for controlling the number of connecting points between the level at issue and another level.

In accordance with this configuration, the circuit information with the physical information extracted and reflected can be optimized from the standpoint of data quantity, circuit simulation time, accuracy, etc.

In this invention, the physical information relates to a parasitic element.

In this invention, the physical information relates a parasitic coupling capacitor element.

In this invention, the physical information relates to the shape parameter of a device.

In this invention, the physical information relates to the model of a device.

In this invention, the physical information relates to a physical parameter.

In this invention, the circuit information relates to a circuit diagram.

In this invention, the circuit information relates to a net list.

This invention relates to a hierarchical circuit data with physical information in which the physical information is added to the hierarchical circuit information using algebras.

In this invention, the physical information is added the circuit information in different levels using algebras.

In this configuration, the data quantity of the hierarchical circuit data with physical information can be reduced.

In this invention, the physical information is added to the hierarchical circuit information using net list creating information.

In this configuration, the data quantity of the hierarchical circuit data with physical information can be reduced.

In this invention, a cell different from the cell to which the layout data refers is referred to so that the physical information equivalent to the layout information is provided.

In accordance with this configuration, the hierarchical circuit data with physical information can be obtained relatively easily.

In accordance with this invention, by reflecting various kinds of physical information existing on a layout on hierarchically organized circuit information while maintaining the accuracy of the physical information, high speed of circuit simulation reflecting the physical information thereon and reduction in the quantity of data can be realized.

### BRIEF DESCRIPTION OF THE DRAWINGS

FIG. 1 is a view of the entire operation of a first embodiment.

FIG. 2 is a view showing an example of determining the physical information belonging to Level 3 in Level 2.

FIG. 3 is a view showing an example of determining the physical information belonging to Level 3 in Level 1.

FIG. 4 is a view showing the entire operation of a third embodiment (modification of the first embodiment).

FIG. 5 is a view showing the entire operation of a fourth embodiment (modification in the first embodiment).

FIG. 6 is a view showing the entire operation of a fifth embodiment (modification of the first embodiment).

FIG. 7 is a view showing the entire operation of a sixth embodiment (modification of the first embodiment).

FIG. 8 is a view showing the operation of a seventh embodiment.

FIG. 9 is an example of hierarchical circuit information with physical information 01906.

FIG. 10 is a view showing the operation of an eighth embodiment.

FIG. 11 is a view showing an example of hierarchical circuit information with physical information 02006.

FIG. 12 is a view showing the operation relative to creation of a net list with physical information in the eighth embodiment.

FIG. 13 is a view showing the operation of a ninth embodiment.

FIG. 14 is a view showing an example of hierarchical circuit information with physical information 02106.

FIG. 15 is a view showing an example of hierarchical circuit information with physical information 02106.

FIG. 16 is a view showing the operation of a tenth embodiment.

FIG. 17 is a view showing the operation of an eleventh embodiment, a thirteenth embodiment and a fourteenth embodiment.

FIG. 18 is a view showing an example of control information 04707 (eleventh, thirteenth and fourteenth embodiments).

FIG. 19 is a view showing an example of hierarchical circuit information with physical information 04706.

FIG. 20 is a view showing the operation of the fourteenth embodiment.

FIG. 21 is a view showing hierarchical circuit information (cell) in the thirteenth embodiment and fourteenth embodiment.

FIG. 22 is a view for explaining the thirteenth embodiment.

FIG. 23 is a view for explaining the thirteenth embodiment.

FIG. 24 is a view for explaining the thirteenth embodiment.

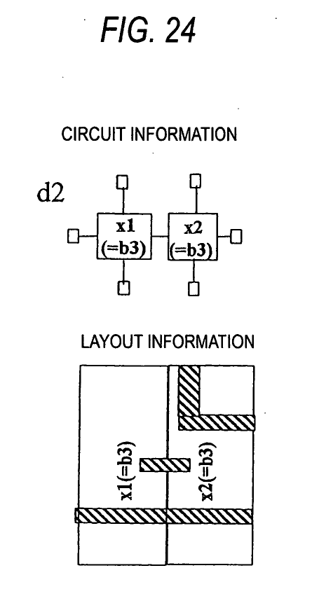

FIG. 25 is a view for explaining the thirteenth embodiment.

FIG. 26 is a view for explaining the thirteenth embodiment.

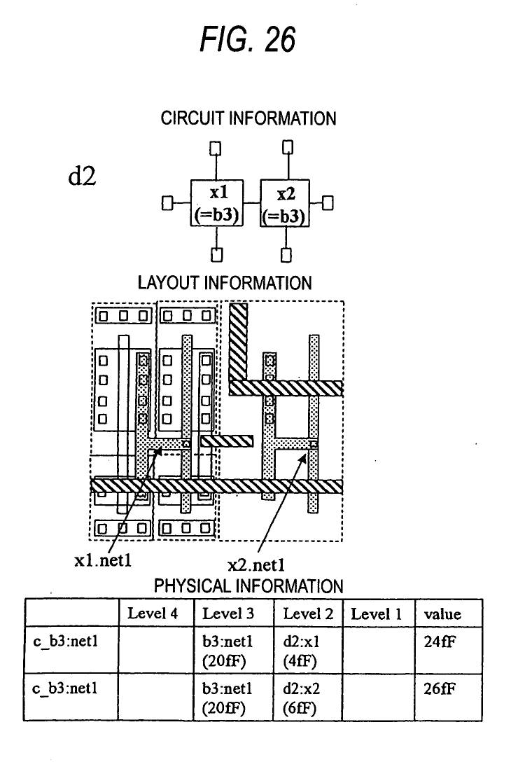

FIG. 27 is a view for explaining the thirteenth embodiment.

FIG. 28 is a view for explaining the thirteenth embodiment.

FIG. 29 is a view for explaining the thirteenth embodiment.

FIG. 30 is a view for explaining the thirteenth embodiment.

FIG. 31 is a view for explaining the thirteenth embodiment.

FIG. 32 is a view for explaining the thirteenth embodiment.

FIG. 33 is a view for explaining the fourteenth embodiment.

FIG. 34 is a view for explaining the fourteenth embodiment.

FIG. 35 is a view for explaining the fourteenth embodiment.

FIG. 36 is a view for explaining the fourteenth embodiment.

FIG. 37 is a view for explaining a fifteenth embodiment.

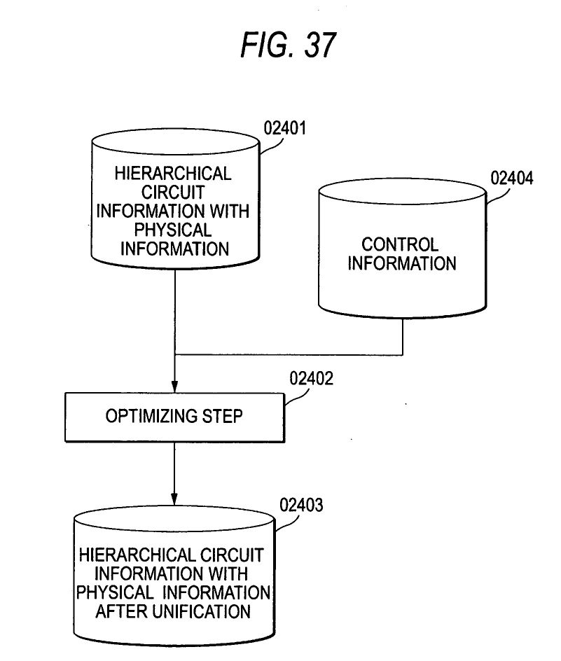

FIG. 38 is a view showing hierarchical circuit information and hierarchical layout information (cell).

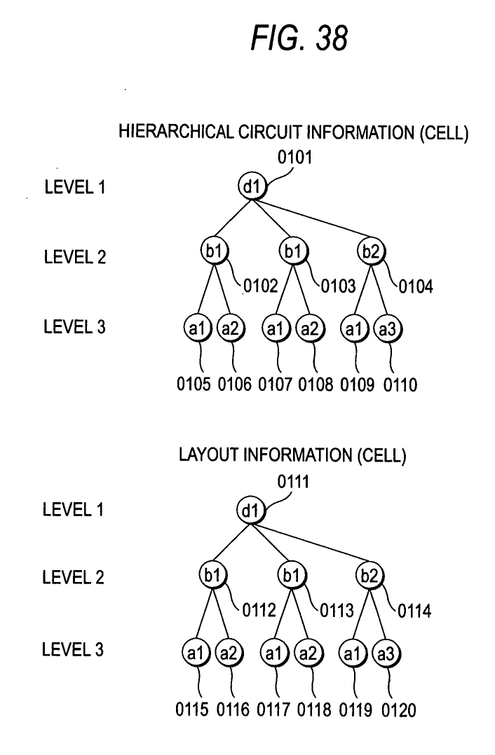

FIG. 39 is a view showing hierarchical circuit information and hierarchical layout information (instance).

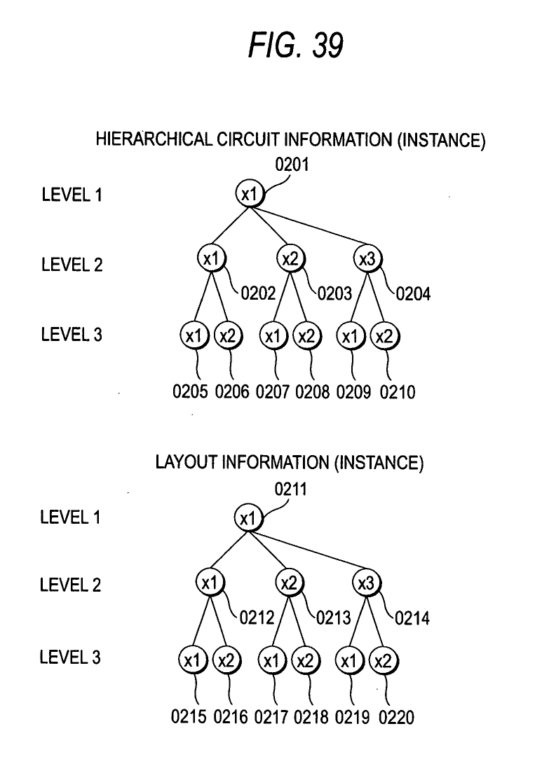

FIG. 40 is a view showing for the circuit information.

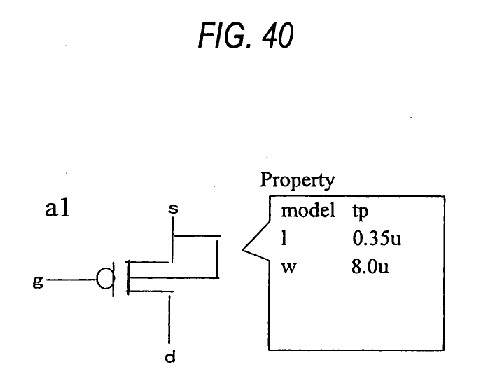

FIG. 41 is a view for explaining the circuit information and layout information.

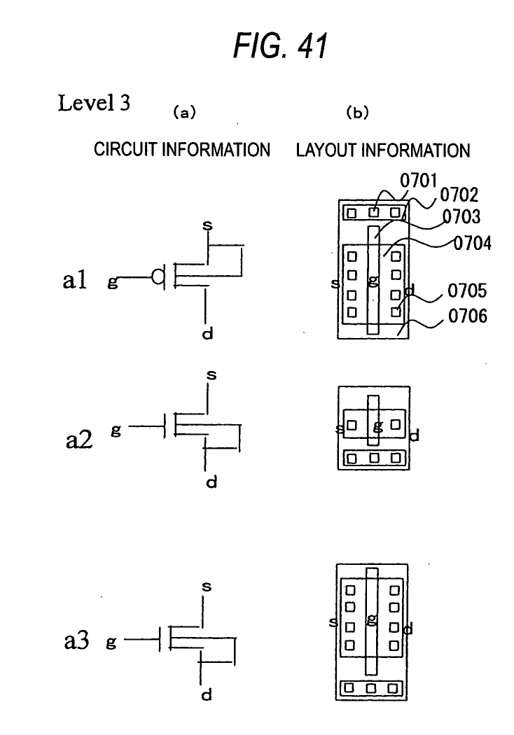

FIG. 42 is a view for explaining the circuit information and layout information.

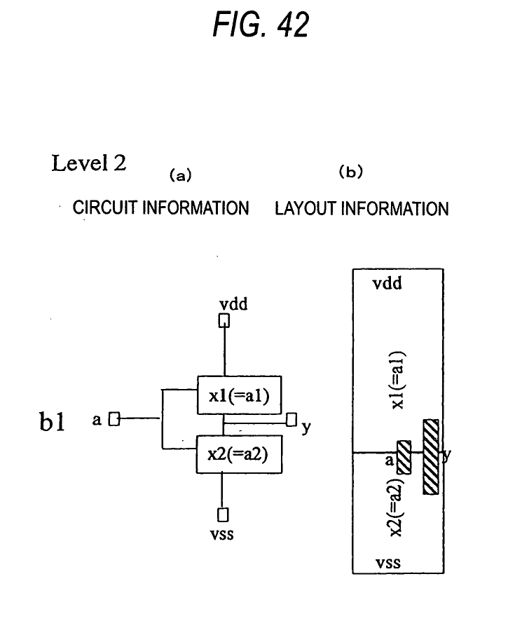

FIG. 43 is a view for explaining the circuit information and layout information.

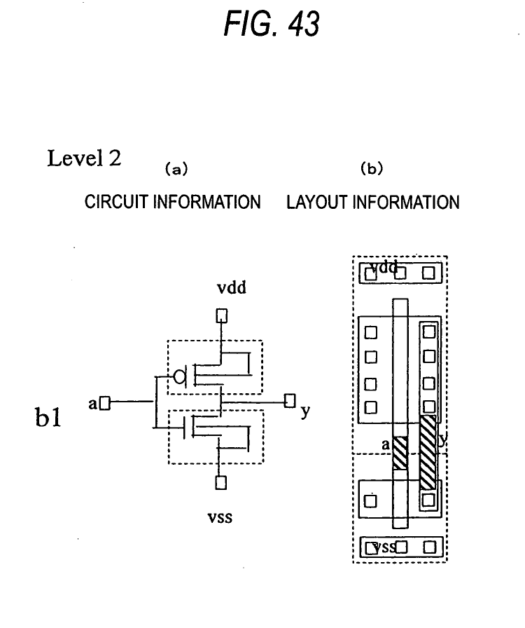

FIG. 44 is a view for explaining the circuit information and layout information.

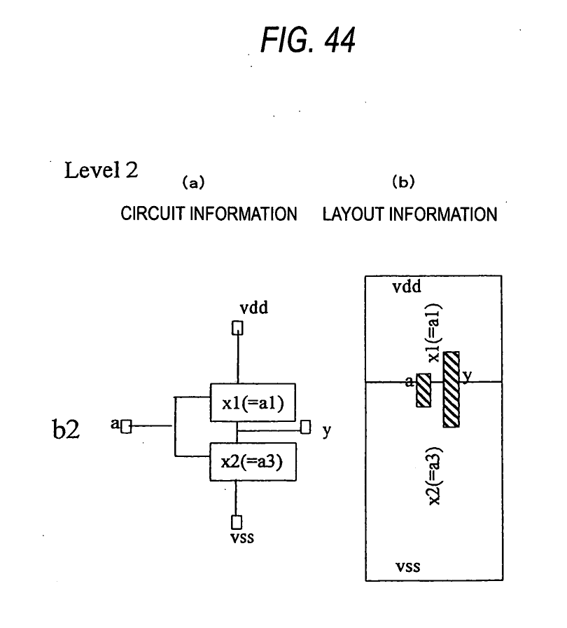

FIG. 45 is a view for explaining the circuit information and layout information.

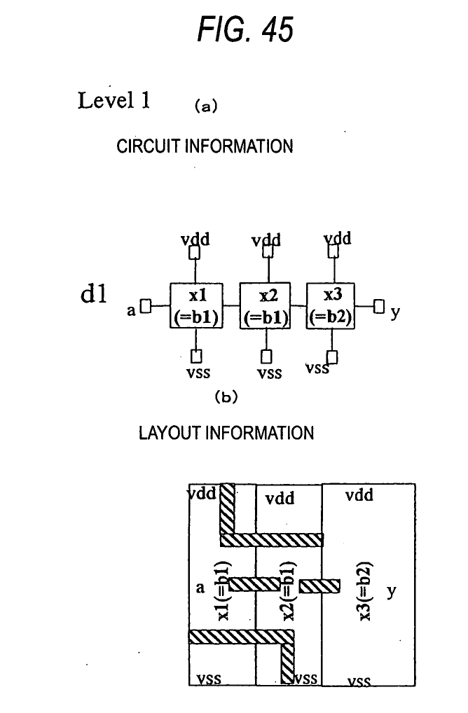

FIG. 46 is a view showing the operation of circuit simulation with no physical information (conventional technique).

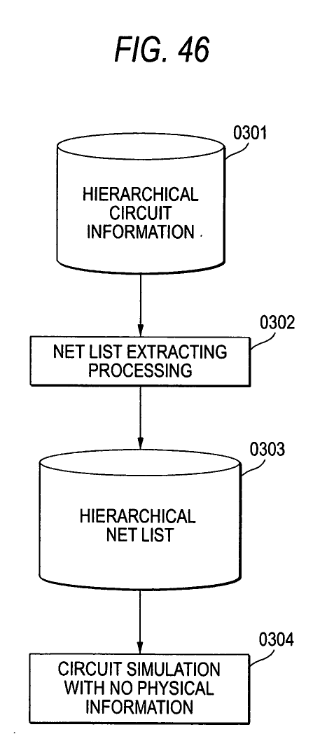

FIG. 47 is a view showing the operation of circuit simulation with physical information (conventional technique).

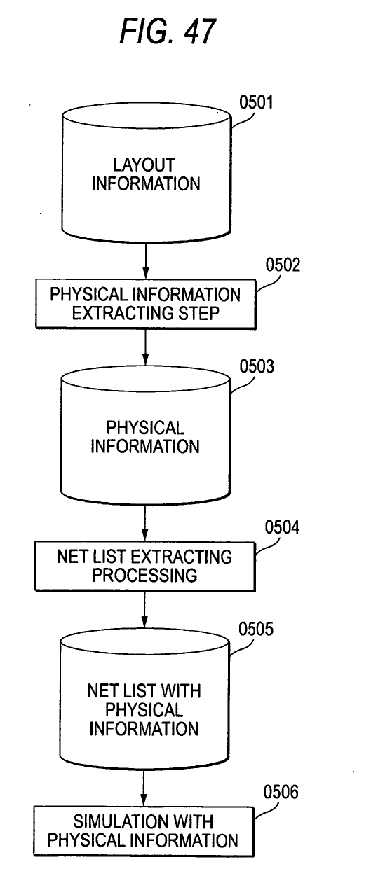

FIG. 48 is a view for explaining flattening (developing) of the layout information.

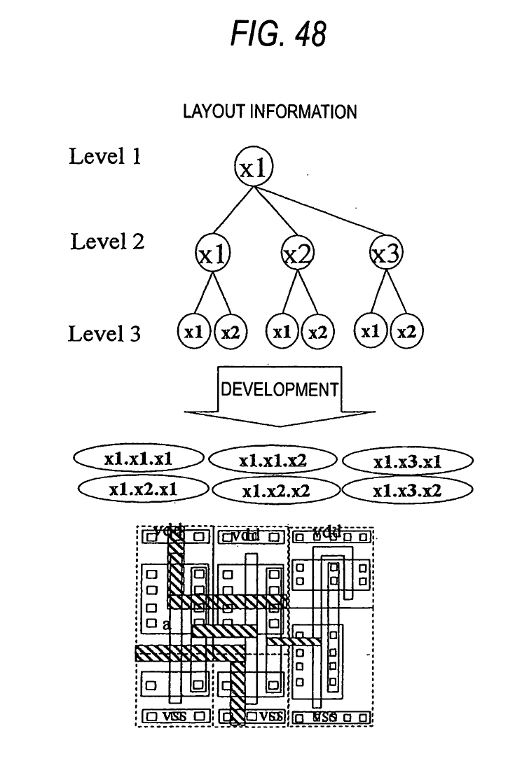

FIG. 49 is a view showing an example of hierarchical net list.

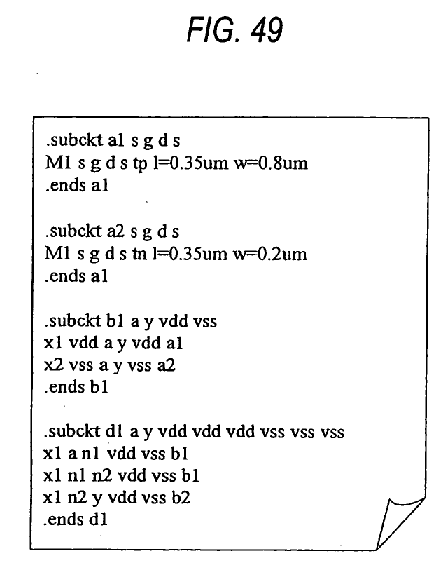

### DESCRIPTION OF THE PREFERRED EMBODIMENTS

Now referring to the drawings, a detailed explanation will be given of various embodiments of this invention. In these embodiments of this invention, like reference numerals refer to like constituents in the prior art for omission of explanation.

### Embodiment 1

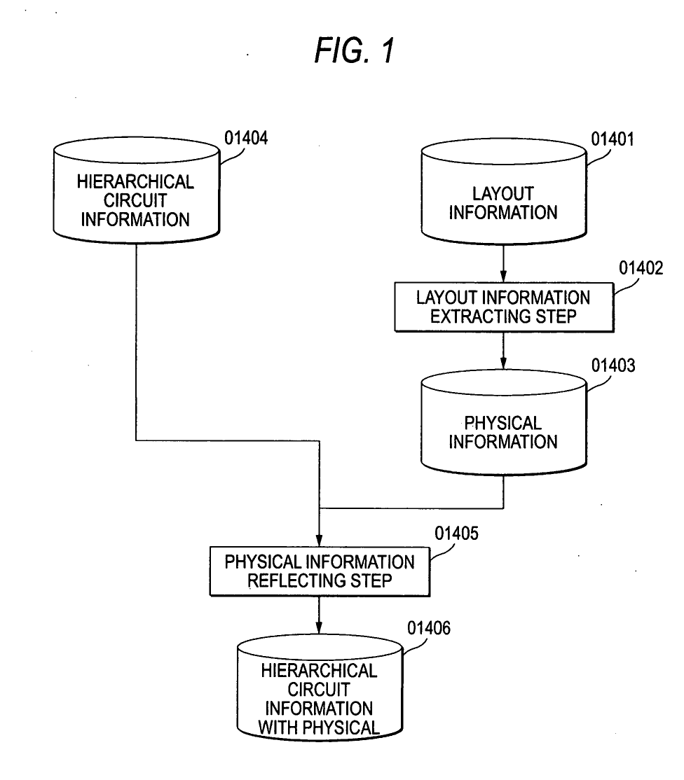

Referring to the drawings, an explanation will be given of a physical information extracting/reflecting method according to the first embodiment of this invention. FIG. 1 is a view showing the entire operation of this invention. In operation, first, layout information 01401 is supplied to a physical information extracting step 01402 thereby to obtain physical information 01403. The technique adopted in the physical information extracting step 01402 may be any suitable technique according to the physical information 01403 to be extracted. Concretely, if the physical information to be extracted is a parasitic element (layout parameter), the technique of LPE (Layout Parameter Extraction) may be adopted. If the information to be extracted is a device characteristic considering the influence of a plasma charging damage, using e.g. the technique of DRC (Design Rule Check), an “antenna ratio” can be computed from the metallic area above the gate portion of a device to provide a damage quantity, thereby providing a device model corresponding to a device characteristic. The physical information 01403 includes a parasitic element and a parasitic coupling capacitor element such as a parasitic resistor and a parasitic capacitor parasitically existing within the layout; a device shape parameter such as a transistor width and the area of a transistor diffused region; a device model indicating a device characteristic; and a physical property parameter attributable to a semiconductor manufacturing process such as a dielectric constant of a separating layer and an interlayer film thickness. The technique adopted in the physical information extracting step 0140 includes LPE (Layout Parameter Extraction), DRC (Design Rule Check) and an optical simulation (ORC: Optical Rule Check).

The physical information extracting step 01402 in this invention is characterized by flattering a lower level of a part or entirety of hierarchically organized layout information to provide physical information and reflecting the extracted physical information on hierarchical circuit information so that it has the information of the level at issue and component for each level.

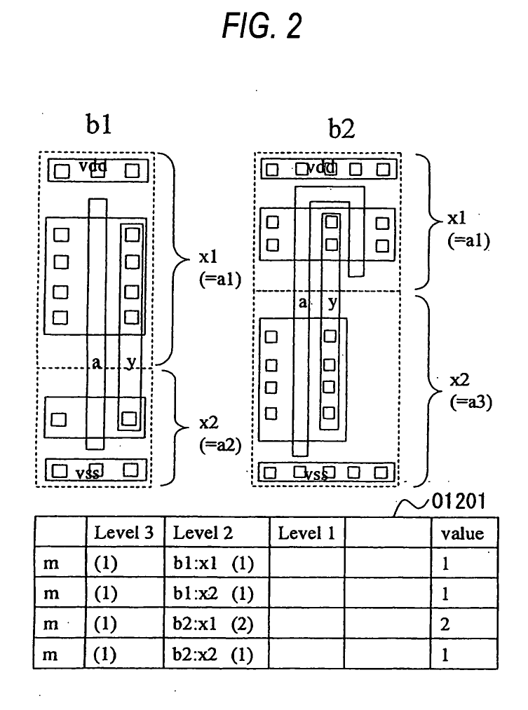

Referring to FIG. 2, an explanation will be given of an example of extracting physical information called a multiplier (division number) m of a transistor by the physical information extracting step 01402. Incidentally, in this embodiment, it is assumed that the cells (b1, b2) at Level 2 are limited in height. Since the physical information called the multiplier of the transistor is the device shape parameter on the transistor, i.e. the cells (a1, a2, a3) at Level 3, it is evident that the physical information called the multiplier of the transistor is the information on Level 3. Next, consideration is made on the Level in which the multiplier m of the transistor is determined. In this embodiment, in Level 2, the cells are limited in height, and in Level 3, the cells are given a transistor width w and transistor length l. So in order to satisfy the height limitation without reducing the transistor width w, the transistor is divisionally used in Level 2. Cell b2 in FIG. 2 is an example thereof. Inversely, if the cell height is fixed in Level 2, the multiplier of the transistor will not change in the level above Level 1. Thus, the Level in which the multiplier m of the transistor is determined is Level 2. In this way, the physical information 01202 having the information on the level of the cell at issue and component for each level is extracted.

With an input of the physical information 01403 thus extracted and the hierarchical circuit information 01404 which is circuit information in a hierarchical structure, the physical information is reflected on the hierarchical circuit information in the physical information reflecting step 01405, thereby providing hierarchical circuit information with physical information 01406.

Accordingly, various kinds of physical information existing on the layout are extracted for the information on the level of the pertinent cell and component for each level is extracted, and can be reflected on the circuit information in the hierarchical structure. By using the hierarchical circuit information with physical information 01406, high speed and reduction in data quantity in the circuit simulation reflecting the physical information can be realized.

### Embodiment 2

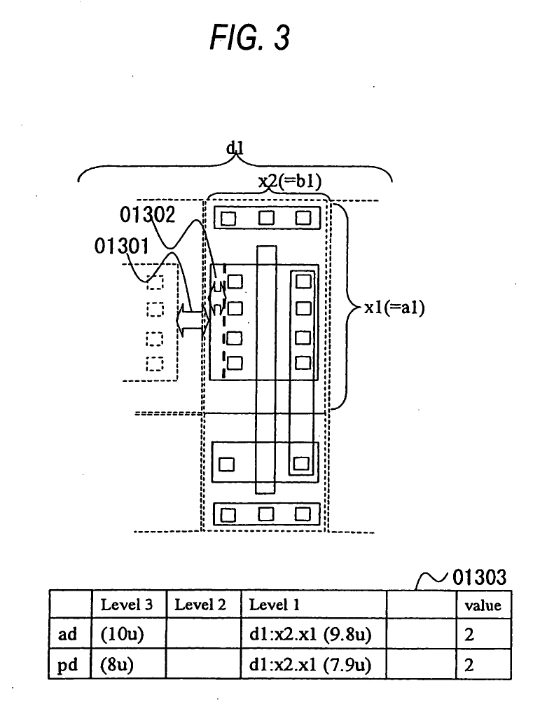

In the first embodiment, the multiplier m was used as the physical information. On the other hand, in this embodiment which is a modification of the first embodiment, a drain diffused area ad, a drain diffused peripheral length pd will be used as the physical information. First, referring to FIG. 3, an explanation will be given of the physical information extracting step of extracting the physical information called the drain diffused area ad and the drain diffused peripheral length pd. Incidentally, it is assumed that the diffused region of the transistor is formed by a semiconductor manufacturing process in which the diffused region changes according to the region of an adjacent transistor isolation layer. The physical information called the drain diffused area ad and drain diffused peripheral length pd of the transistor is a device shape parameter on the transistor, i.e. the cells (a1, a2, a3) at Level 3. Therefore, it is evident that this physical information is the information on Level 3.

Next, consideration is made on the Level in which the the drain diffused area ad and drain diffused peripheral length pd of the transistor are determined. In this embodiment, the diffused region changes according to the region of an adjacent transistor isolation layer so that the above physical information is determined after the adjacent transistor has been arranged. In FIG. 3, as regards the transistor in the lower level x1 of instance x2 within cell d1, since the adjacent transistor has been arranged, its diffused region is determined. For example, in the semiconductor manufacturing process at issue, according to the transistor isolation width 01301, the diffused region is reduced by 01302. Thus, the physical information 01303 having the information on the level at issue and component for each level is extracted.

As described above, for a part or entirety of the layout information necessary to extract the information on the level at issue and component for each level, the lower level is developed to extract the physical information. Incidentally, even if the layout portion corresponding to the circuit information hierarchically organized is not hierarchically organized, as long as its correspondence to the circuit information in the level on which the physical information is evident, the physical information may be likewise extracted.

### Embodiment 3

As the third embodiment of this invention, an explanation will be given of a method for creating the physical information in a target semiconductor manufacturing process by using difference information between both semiconductor manufacturing processes on the basis of the physical information extracted from the layout of another semiconductor manufacturing process different from the target semiconductor manufacturing process.

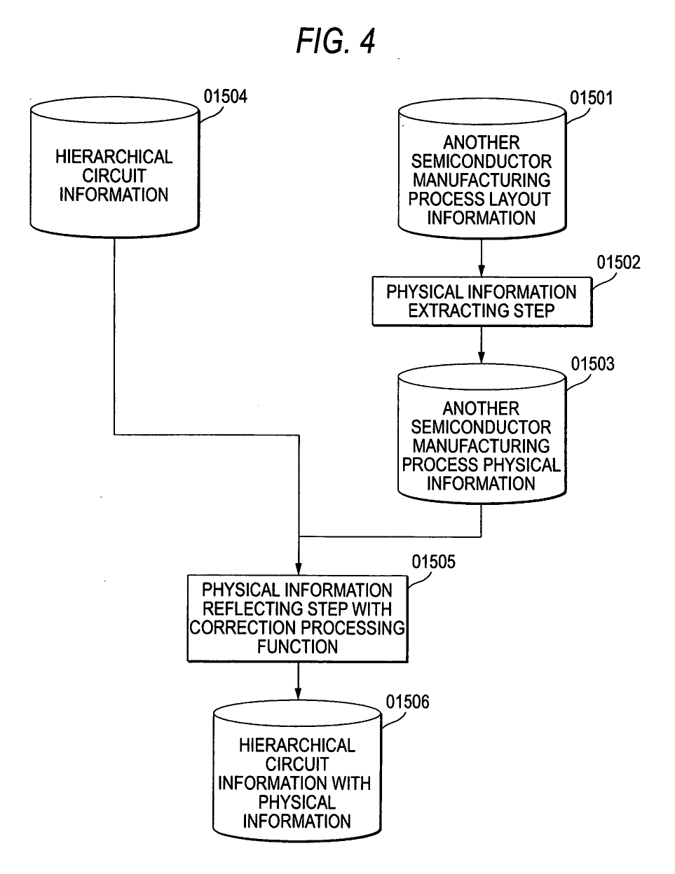

FIG. 4 is a view showing the entire operation of a method for creating the physical information in a target semiconductor manufacturing process by using difference information between both semiconductor manufacturing processes on the basis of the physical information extracted from the layout of another semiconductor manufacturing process different from the target semiconductor manufacturing process.

It is assumed that the layout information 01501 in the semiconductor manufacturing process different from the target layout information exists beforehand.

First, in a physical information extracting step 01502, physical information 01503 is extracted from the layout information in another semiconductor manufacturing process. In this case, if the physical information 01503 in another semiconductor manufacturing process 01503 extracted in previous designing exists beforehand, it is not necessary to newly extract this physical information 01503.

Next, in a physical information reflecting step 01505 with a correction processing function, on the basis of the difference information between another semiconductor manufacturing process and the target semiconductor manufacturing process, the value of the physical information 01503 extracted is corrected, and the correction result is reflected on the hierarchical circuit information 01504, thereby creating hierarchical information with the physical information 01506.

Thus, in accordance with this invention, the processing time taken for extraction of the physical information can be shortened. In addition, even if there is no layout in the target semiconductor manufacturing process, the hierarchical circuit information with the physical information can be obtained.

### Embodiment 4

As the fourth embodiment of this invention, an explanation will be given of a method for creating the layout information and physical information in a target semiconductor manufacturing process by using difference information between both semiconductor manufacturing processes on the basis of the physical information extracted from the layout for another semiconductor manufacturing process different from the target semiconductor manufacturing process.

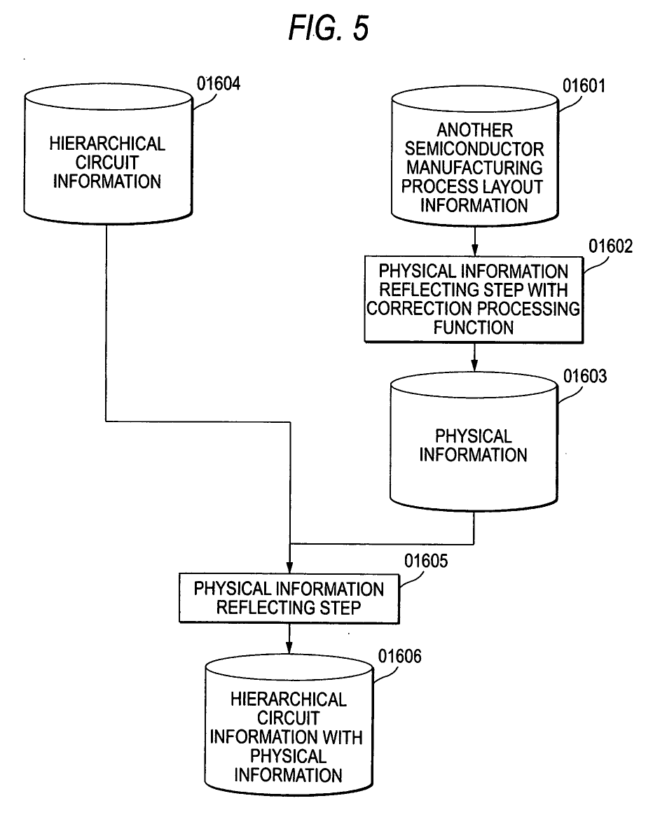

FIG. 5 is a view showing the entire operation of a method for creating the layout information and physical information in a target semiconductor manufacturing process by using difference information between both semiconductor manufacturing processes on the basis of the physical information extracted from the layout of another semiconductor manufacturing process different from the target semiconductor manufacturing process.

It is assumed that the layout information 01601 for the semiconductor manufacturing process different from the target layout information exists beforehand.

First, in a physical information extracting step with a correction processing function 01602, another semiconductor manufacturing process layout information 01601 is corrected on the difference information between a target semiconductor manufacturing process and another semiconductor manufacturing process and its physical information is extracted, thereby extracting the physical information 01603 of the target semiconductor manufacturing process.

Next, in a physical information reflecting step 01605, the physical information 01603 thus extracted is reflected on hierarchical circuit information 01604, thereby creating hierarchical circuit information with physical information 01606.

Therefore, in accordance with this embodiment, even if there is no layout for the target semiconductor manufacturing process, the layout information and hierarchical circuit information with physical information of the target semiconductor manufacturing process can be obtained. Namely, the designing number of man-hours and designing period can be reduced.

### Embodiment 5

As the fifth embodiment of this invention, an explanation will be given of a method for creating the physical information of a target layout by using difference information between both layouts on the basis of the physical information extracted from the information of another layout different from the target layout.

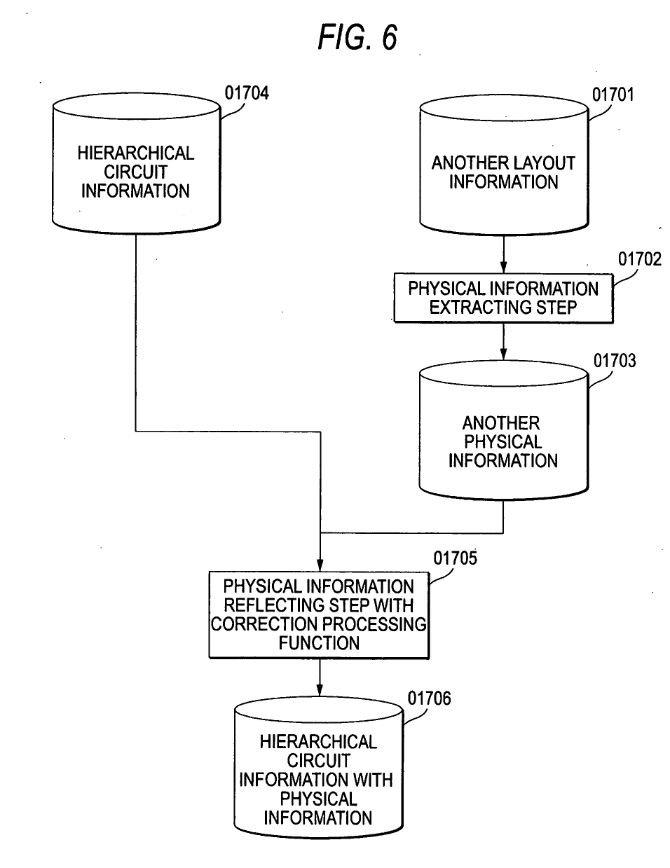

FIG. 6 is a view showing the entire operation of a method for creating the physical information of a target layout by using difference information between both layouts on the basis of the physical information extracted from the information another layout different from the target layout.

Where circuit correction or layout correction is made for the layout already designed, it is assumed that another layout information 01701 different from the target layout information exists beforehand.

First, in a physical information extracting step 01702, another physical information 01703 is extracted from another layout information 01701. In this case, if the physical information 01703 extracted in previous designing exists beforehand, it is not necessary to newly extract this physical information 01703.

Next, in a physical information reflecting step 01705 with a correction processing function, on the basis of the difference information between another layout and the target layout, the value of the physical information 01703 extracted is corrected, and the correction result is reflected on hierarchical circuit information 01704, thereby creating hierarchical information with the physical information 01706.

Thus, in accordance with this invention, the processing time taken for extraction of the physical information can be shortened. In addition, even if there is no target layout, the hierarchical circuit information with physical information can be obtained.

### Embodiment 6

As the sixth embodiment of this invention, an explanation will be given of a method for creating the information of a target layout by using the difference information between the target layout and another layout.

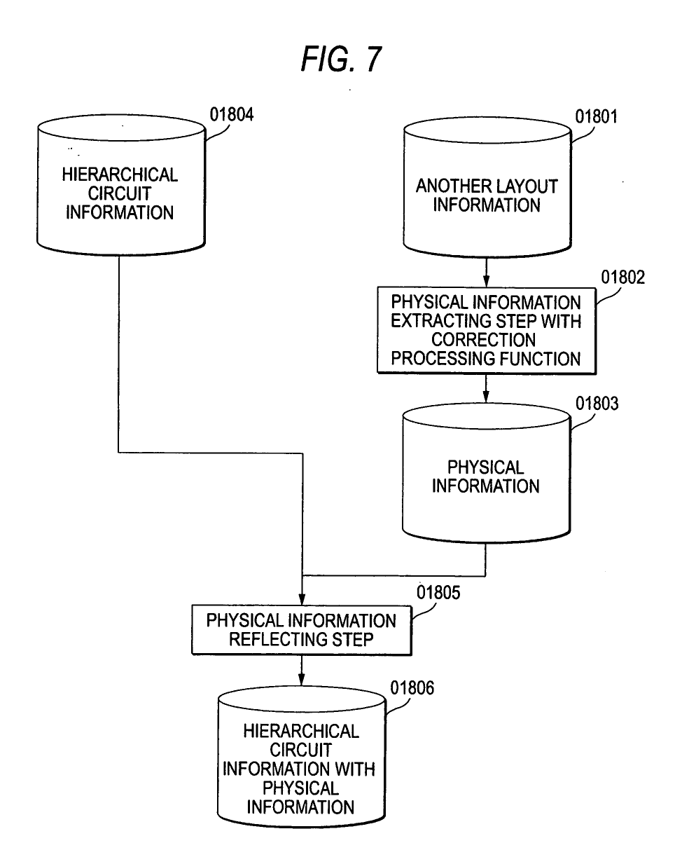

FIG. 7 is a view showing the entire operation of a method for creating the layout information of a target layout by using the difference information between the target layout and another layout.

Where circuit correction or layout correction is made for the layout already designed, it is assumed that another layout information 01801 different from the target layout information exists beforehand.

First, in a physical information extracting step with a correction processing function 01802, another layout information 01801 is corrected on the basis of the difference information between a target layout and another layout and its physical information is extracted, thereby extracting the physical information 01803 of the target layout.

Next, in a physical information reflecting step 01805, the physical information 01803 thus extracted is reflected on hierarchical circuit information 01804, thereby creating hierarchical circuit information with physical information 01806.

Therefore, in accordance with this invention, even if there is no layout for the target semiconductor manufacturing process, the layout information and hierarchical circuit information with physical information of the target semiconductor manufacturing process can be obtained. Namely, the designing number of man-hours and designing period can be reduced.

### Embodiment 7

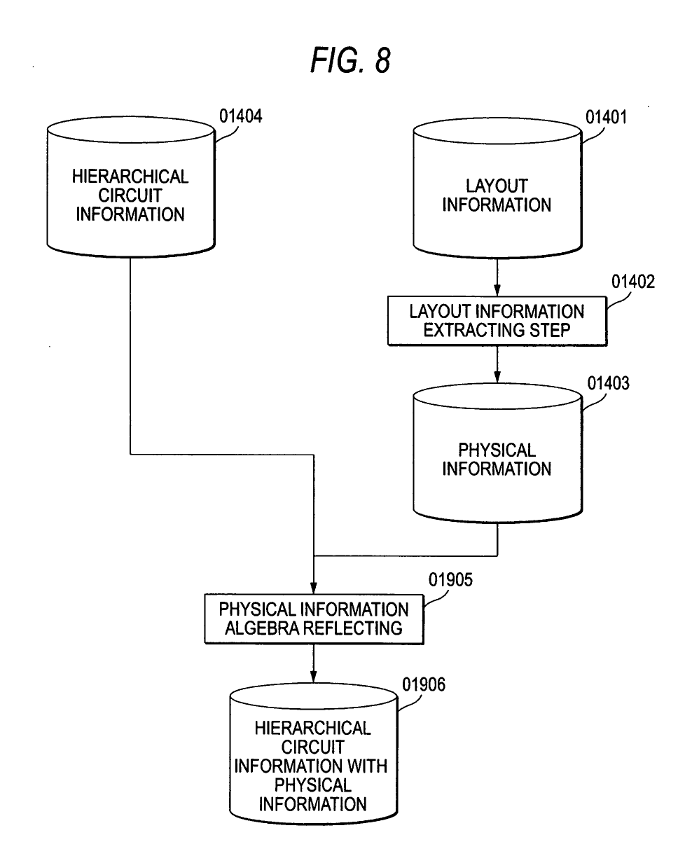

Now referring to the drawings, an explanation will be given of a physical information extracting/reflecting method according to the seventh embodiment of this invention. FIG. 8 is a view showing the operation of the seventh embodiment. The operation of this embodiment, which is the same as that of the first embodiment except that the physical information reflecting step 01405 is replaced by physical information algebra reflecting step 01905, will not be explained in detail here.

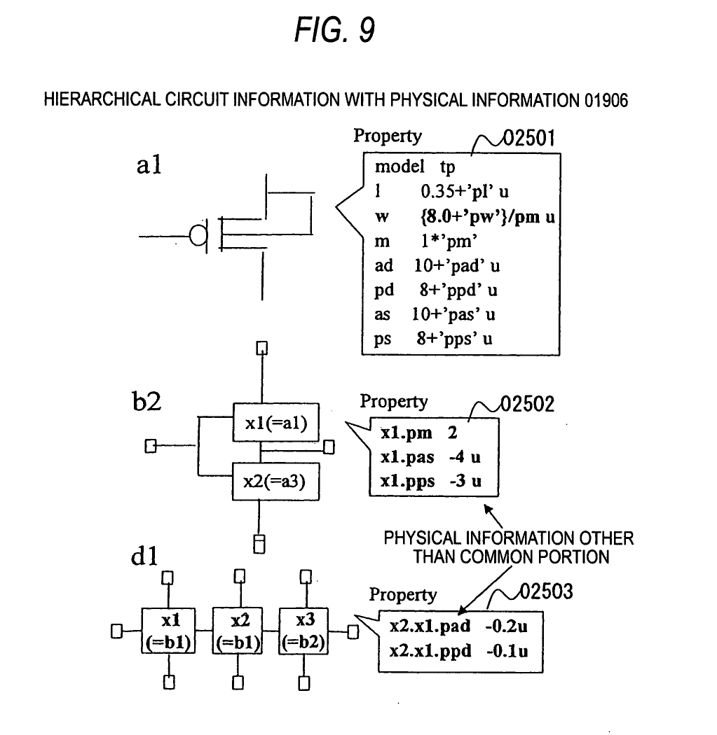

In this embodiment, with an input of the physical information 01403 and the hierarchical circuit information 01404 which is the circuit information hierarchically organized, in the physical information algebra reflecting step 01905, the physical information is reflected on the hierarchical circuit information, thereby providing the hierarchical circuit information with physical information 01906. Concretely, as the physical information 01403, where the physical information 01201 (FIG. 2) and the physical information 01303 (FIG. 3) are extracted, the hierarchical circuit information with physical information 01906 is as shown in FIG. 9.

Referring to FIG. 9, an explanation will be given of the physical information algebra reflecting step 01905 and the hierarchical circuit information with physical information 01906. In the physical information algebra reflecting step 01905, first, an algebra is defined in the level to which the physical information to be reflected belongs. Concretely, since the physical information should be reflected on the transistor length l, transistor width w, transistor multiplier m, drain diffused area ad, drain diffused length pd, source diffused area as and source diffused length ps of cell a1, algebras of pl, pw, pm, pad, ppd, pas and pps are defined (02501) Next, values are assigned from the level with the physical information determined. As regards the physical information 01201, since the transistor multiplier of instance x1 within cell b2 is 2, the value of x1.pm=2 is assigned to cell b2 (. (dot) represents a level stop). Likewise, the values of x1.pas=−4u (u:μm) and x1.pps=−3u are assigned to cell b2. Further, the values of x2.x1.pad=−0.2 and x1.ppd=−0.1u are assigned to cell d1. In this way, the algebras are defined in the belonging level of the physical information, and the values are assigned in order from the level with the physical information determined. Thus, the physical information could be given while the hierarchical structure is kept. The hierarchical circuit information with physical information 01906 obtained by the physical information algebra reflecting step 01905 is characterized in that it has a small quantity of data. However, if the physical information to be reflected increases, the processing time taken for parameter deliver in the circuit simulation also lengthens. For this reason, as in this embodiment, it is effective to reflect only the physical information other than common information, i.e. the changing physical information.

In accordance with this embodiment, by reflecting the physical information on the circuit information hierarchically organized, the high speed of the circuit simulation with the physical information reflected thereon can be realized. In addition, the quantity of data can be reduced.

Incidentally, all items of physical information inclusive of the common physical information, i.e. non-changeable physical information can be assigned as algebras.

Further, in this embodiment, the changed degree (difference) was defined by the algebra, but the numerical value itself can be defined by the algebra. Concretely, with a definition of ad=pad, it may be assumed that x2.x1.pad=−9.8u.

Further, if a relationship equation can be defined between the items of the physical information, the algebra may be defined so that certain physical information can be replaced by another physical information. Concretely, the transistor width w may be algebraically defined as an equation of pw and pm. Thus, the physical information can be easily reflected.

### Embodiment 8

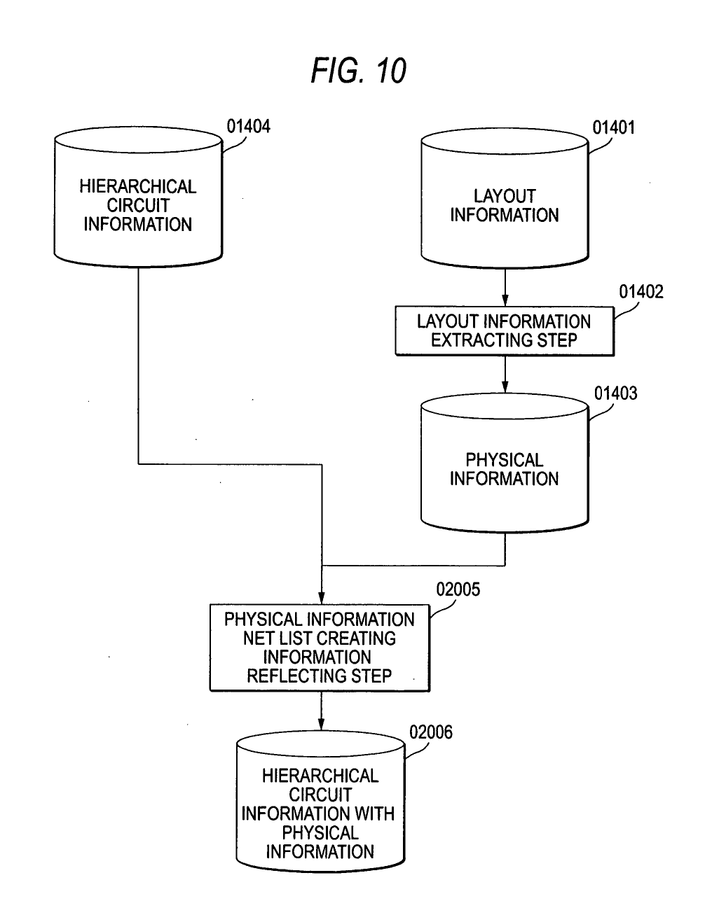

Now referring to the drawings, an explanation will be given of a physical information extracting/reflecting method according to the eighth embodiment of this invention. FIG. 10 is a view showing the operation of the eighth embodiment. The operation of this embodiment, which is the same as that of the seventh embodiment except that in FIG. 8, the physical information algebra reflecting step 01905 is replaced by a physical information net list creating information reflecting step, will not be explained in detail here.

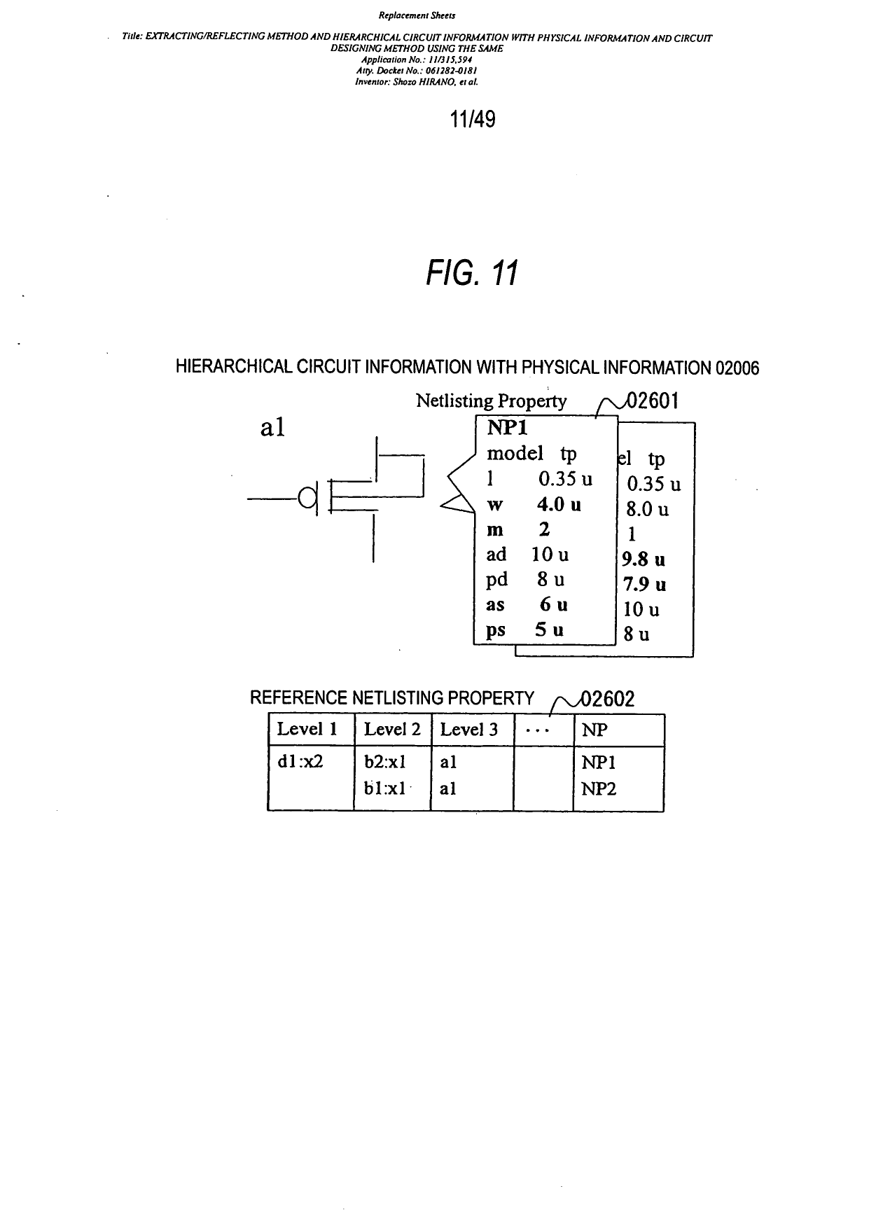

In this embodiment, with an input of the physical information 01403 and the hierarchical circuit information 01404 which is the circuit information hierarchically organized, in the physical information net list creating information reflecting step 02005, the physical information is reflected on the hierarchical circuit information, thereby providing the hierarchical circuit information with physical information 02006. Concretely, as the physical information 01403, where the physical information 01201 (FIG. 2) and the physical information 01303 (FIG. 3) are extracted, the hierarchical circuit information with physical information 02006 is as shown in FIG. 11.

Referring to FIG. 11, an explanation will be given of the physical information net list creating information reflecting step 02005 and the hierarchical circuit information with physical information 02006. In the physical information net list creating information reflecting step 02005, first, the cell in the level to which the physical information to be reflected belongs is selected. Concretely, cell a1 is selected. Next, a netlisting property 02601 and a reference netlisting property 02602 are defined for cell a1. The property information contains the physical information. Finally, hierarchical circuit information with physical information 02006 having the netlisting property 02601 and the reference netlisting property 02602 is provided.

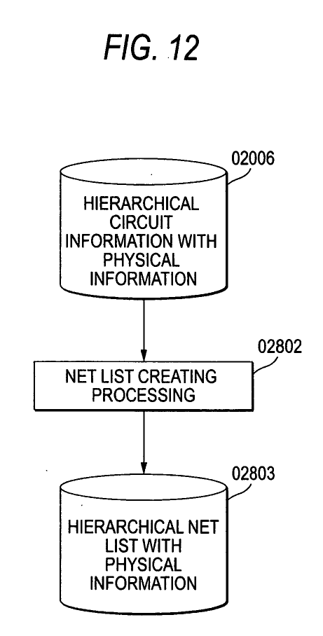

In carrying out the circuit simulation, according to the operation view of FIG. 12, the hierarchical circuit information with physical information 02006 is supplied to the net list creating processing 02802. In the net list creating processing 02802, referring to the reference netlisting property 02602, where cell 1 is in the level under a predetermined condition, the property information of the defined netlisting property (NP1, NP2) is provided. In this way, the physical information could be given while the hierarchical structure is kept. The hierarchical circuit information with physical information 02006 obtained by the physical information net list creating information reflecting step 02005 is characterized in that it has a small quantity of data, and even if the physical information to be reflected is increased, the processing time taken for the net list creating processing 02802 is not so greatly lengthened.

In accordance with this embodiment, by reflecting the physical information on the circuit information hierarchically organized, the high speed of the circuit simulation with the physical information reflected thereon can be realized. In addition, the quantity of data can be reduced.

### Embodiment 9

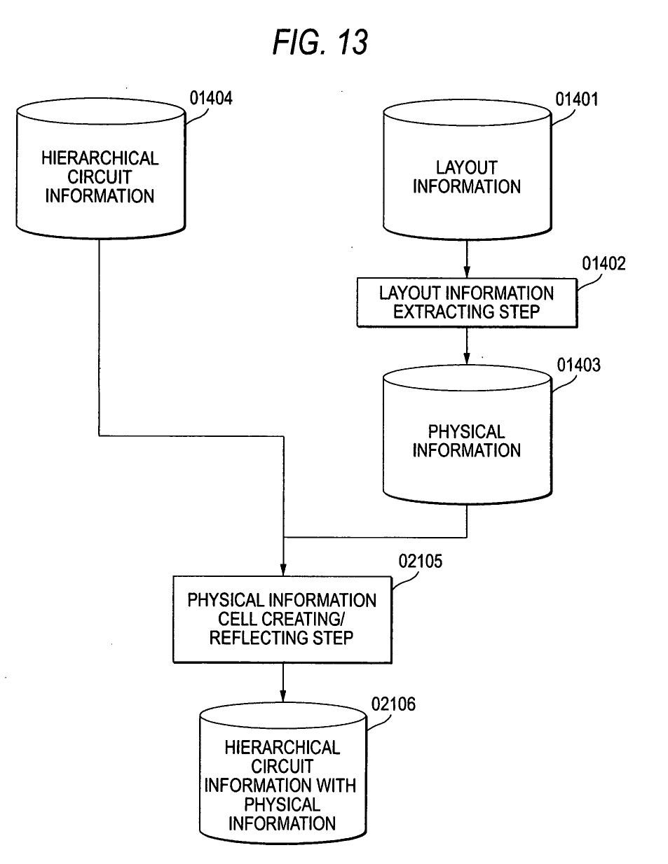

Now referring to the drawings, an explanation will be given of a physical information extracting/reflecting method according to the ninth embodiment of this invention. FIG. 13 is a view showing the operation of the ninth embodiment. The operation of this embodiment, which is the same as that of the seventh embodiment except that in FIG. 8, the physical information algebra reflecting step 01905 is replaced by a physical information cell creating/reflecting step 02105, will not be explained in detail here.

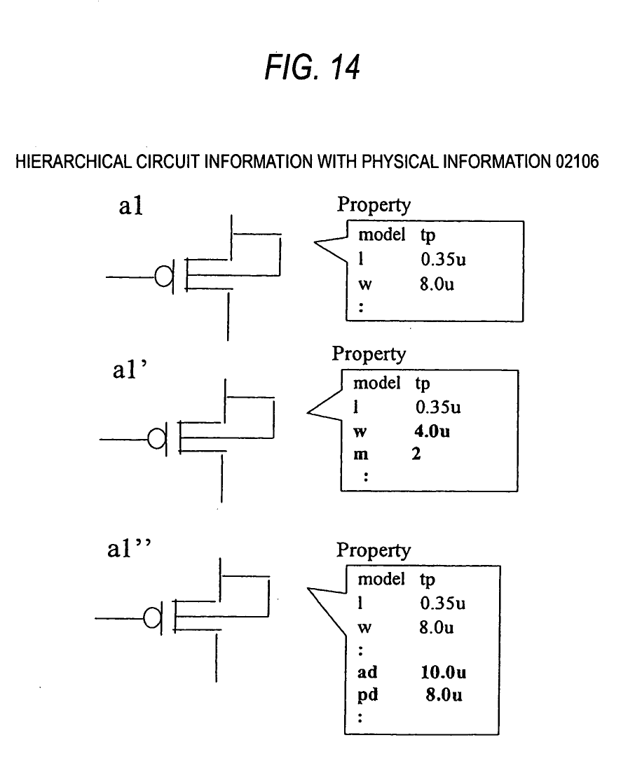

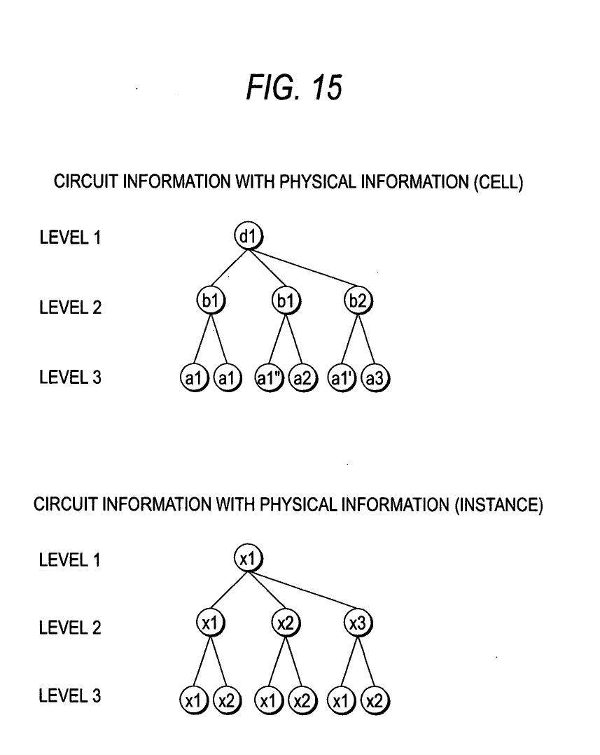

In this embodiment, with an input of the physical information 01403 and the hierarchical circuit information 01404 which is the circuit information hierarchically organized, in the physical information cell creating/reflecting step 02105, the physical information is reflected on the hierarchical circuit information, thereby providing the hierarchical circuit information with physical information 02106. Concretely, as the physical information 01403, where the physical information 01201 (FIG. 2) and the physical information 01303 (FIG. 3) are extracted, the hierarchical circuit information with physical information 02006 is as shown in FIGS. 14 and 15.

Referring to FIGS. 14 and 15, an explanation will be given of the physical information cell creating/reflecting step 02105 and the hierarchical circuit information with physical information 02106. In the physical information cell creating/reflecting step 02105, first, the cell in the level to which the physical information to be reflected belongs is selected. Concretely, cell a1 is selected. Next, cell a1′ and cell a1″ on which the physical information is reflected are created for cell a1. Further, as shown in FIG. 15, the reference source cell of instance x1 for cell b2 is changed from a1 to a1′. The reference source cell of instances x2, x1 for cell d1 is changed from a1 to a1″. In this way, the physical information could be given while the hierarchical structure is kept. The hierarchical circuit information with physical information 02106 obtained by the physical information cell creating/reflecting step 02105 is characterized in that it gives a small increase in the simulation processing time, but a larger quantity of data due to cell creation than in the seventh embodiment and eighth embodiment.

In accordance with this embodiment, by reflecting the physical information on the circuit information hierarchically organized, the high speed of the circuit simulation with the physical information reflected thereon can be realized.

### Embodiment 10

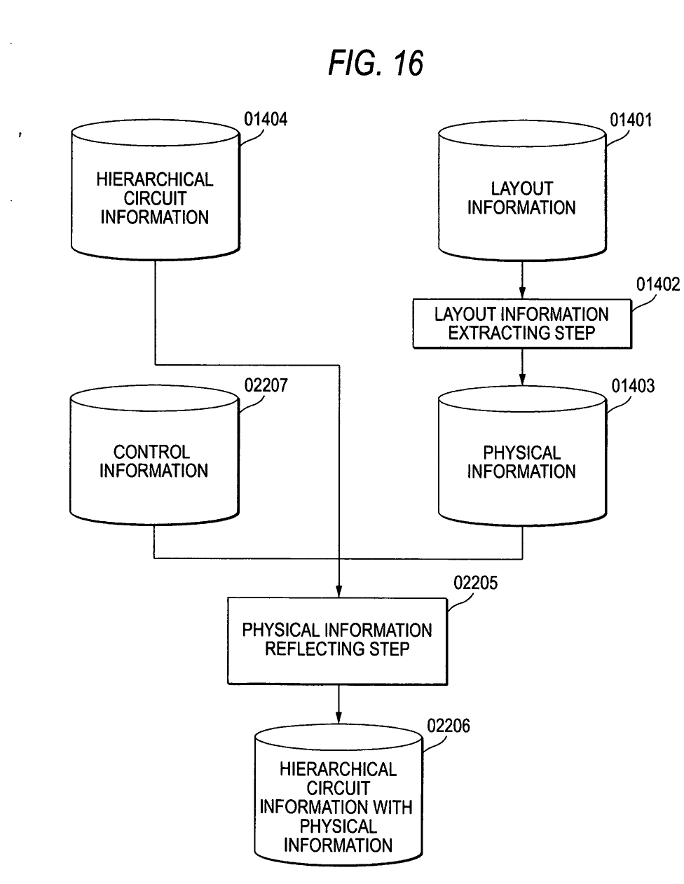

Now referring to the drawing, an explanation will be given of a physical information extracting/reflecting method according to the tenth embodiment of this invention. FIG. 16 is a view showing the operation of the tenth embodiment. The operation of this embodiment, which is the same as that of the first embodiment except that in FIG. 1, the physical information reflecting step 01405 is replaced by a physical information reflecting step 02205 and control information 02207 is added, will not be explained in detail here.

The control information 02207 is input information for setting an optimization target for the quantity of data and a circuit simulation time. In the physical information reflecting step 02205, the technique suitable to the optimization target set in the control information 02207 is selected for each item of the physical information to be reflected from the physical information algebra reflecting step in the seventh embodiment (FIG. 8), the physical information net list creating information reflecting step in the eighth embodiment (FIG. 10) and the physical information cell creating/reflecting step in the ninth embodiment (FIG. 13). Concretely, if the physical information should be reflected on the cell in Level 3 whose data quantity is small, the physical information cell creating/reflecting step is selected. If the physical information should be reflected on the cell in Level 2 or above, the physical information net list crating information creating step is selected, for example. In this way, the suitable technique is automatically selected for each physical information. Incidentally, the technique suitable to the optimization target may be manually selected.

In accordance with this embodiment, by reflecting the physical information on the circuit information hierarchically organized, the high speed of the circuit simulation with the physical information reflected thereon can be realized. In addition, the data quantity and circuit simulation time can be optimized.

### Embodiment 11

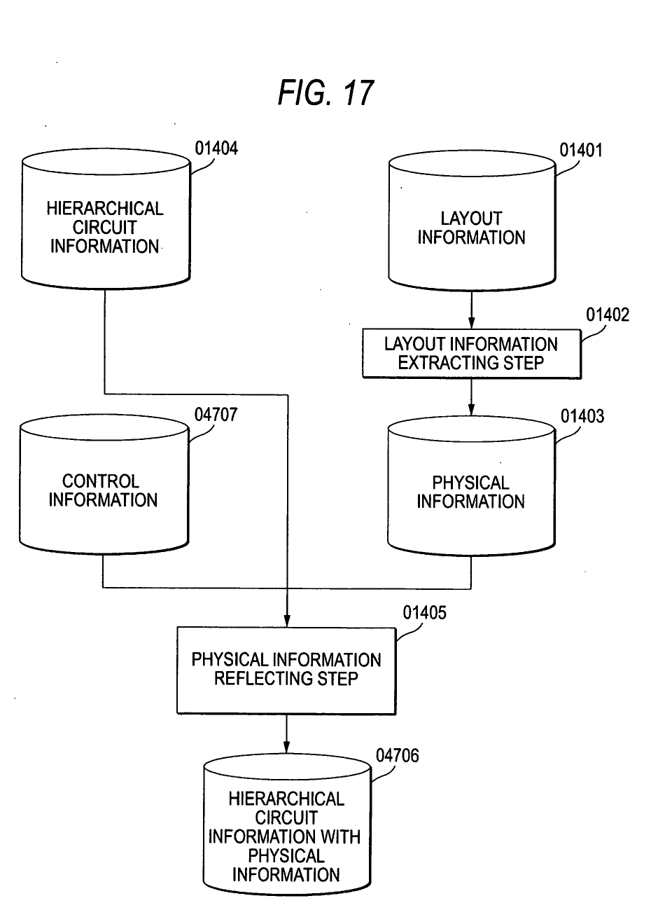

Now referring to the drawing, an explanation will be given of a physical information extracting/reflecting method according to the eleventh embodiment of this invention. FIG. 17 is a view showing the operation of the tenth embodiment. The operation of this embodiment, which is the same as that of the first embodiment except that in FIG. 1, control information 04707 is added, will not be explained in detail here.

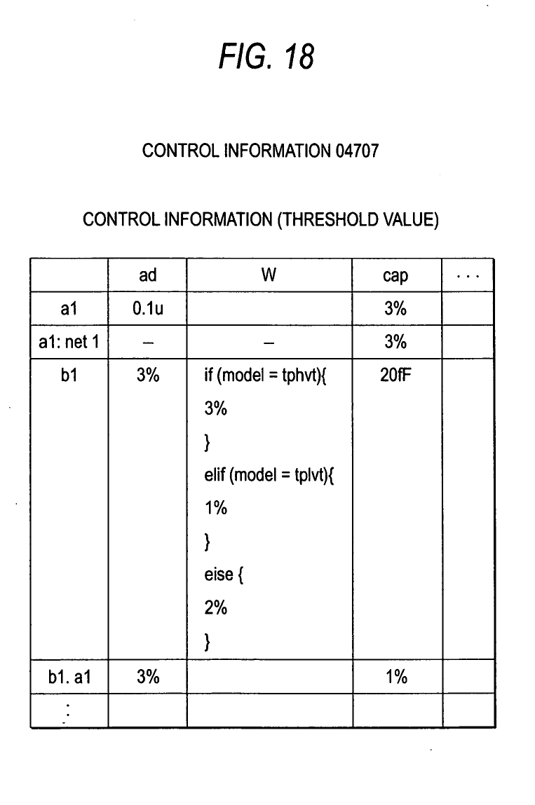

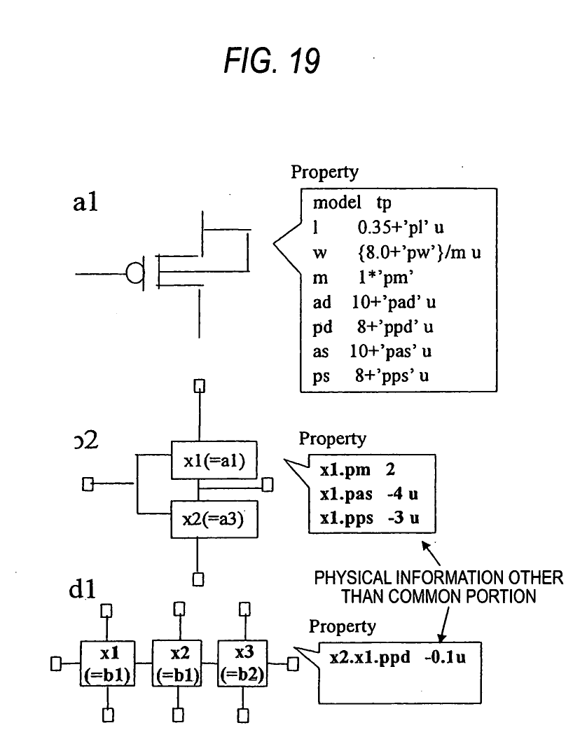

The control information 04707 is characterized in that if the physical information is not higher than or lower than a preset threshold value, these items of physical information are unified in the same physical information which is reflected on the hierarchical circuit information. FIG. 18 is a view showing an example of the physical information 04707. The threshold value of the drain diffused area ad of cell a1 is set at 0.1 μm². Therefore, if the difference among the drain diffused areas ad of two or more cells a1 is not larger than 0.1 μm², the same value can be adopted for each cell a1. Further, the threshold value of the drain diffused area ad of cell b1 is set at 3% or less. Therefore, the difference among the drain diffused areas ad of the same cells a1 within two or more cells b1 is not larger than 3%, the same value can be adopted for each cell b1. For cell a1 within cell b1, since the threshold value set for cell a1 is different from that set for cell b1, b1.a1 is set at 1% or less. If different threshold values are set for the higher level and lower level, they may be set individually as described above, or otherwise which level should be given priority may be set individually or impartially. In this way, the threshold value of the physical information ad was set. Referring to FIG. 9, ad of instance x1 (=a1) within cell b2 is 10u, and ad of cell a1 within cell b1 is 9.8u. Since a 3% change of ad is permitted for cell a1 within cell b1, cell a1 is permitted to have the values from 10.094u to 9.506u (9.8u×3/100=0.294u). Thus, these values are unified in 10u. By this unification, the hierarchical circuit information with physical information in FIG. 9 can be changed to the hierarchical circuit information with physical information in FIG. 19.

In accordance with this embodiment, by setting the threshold value for the control information and summarizing it as the same physical information, the data quantity and circuit simulation time can be optimized.

Incidentally, like the threshold value of the transistor width w set for cell b1 in FIG. 18, the threshold value can be set by a condition equation, an evaluation equation, etc.

In this example, if the pertinent transistor is a model with high Vt (tphvt), the transistor widths within a change of 3%, they are unified in the same physical information. If the pertinent transistor is a model with low Vt (tplvt), the transistor widths within a change of 1% are unified in the same physical information. If the pertinent transistor is the other model, the transistor widths within a change of 2% are unified in the same physical information.

In the unification in the same physical information, the average value, the maximum value, minimum value and an effective maximum value and an effective minimum value can be used.

Further, as a modification of the eleventh embodiment, it is also possible to set optimization of the data quantity, circuit simulation time and circuit simulation accuracy for the control information and automatically set the threshold value suitable to target setting. Concretely, for the physical information and cell whose influencing on the accuracy of the circuit simulation may be set at a low degree, a larger threshold value for equalization may be automatically set.

### Embodiment 12

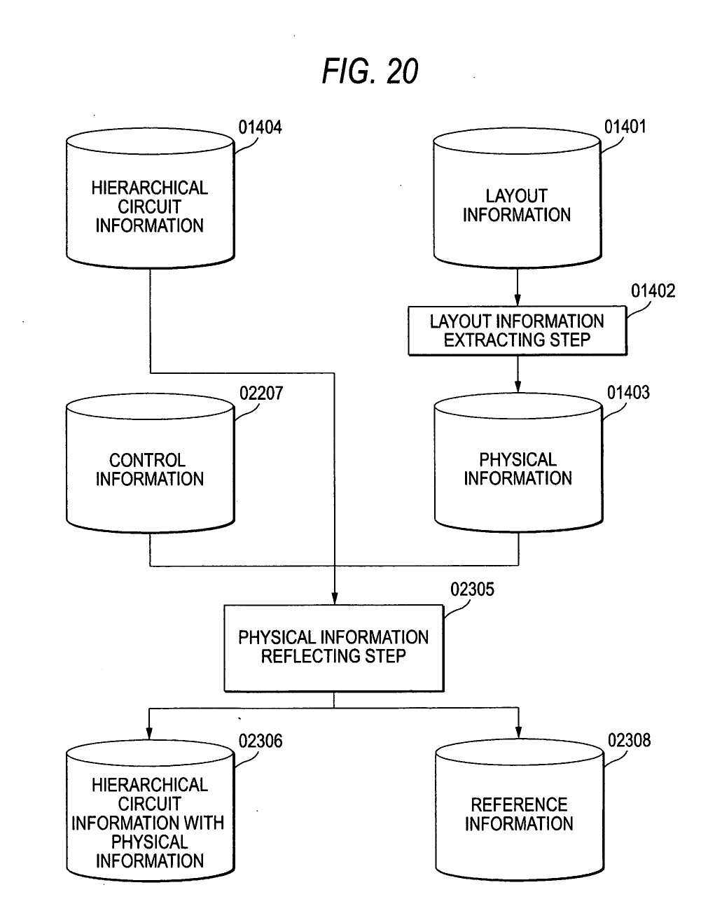

Now referring to the drawings, an explanation will be given of a physical information extracting/reflecting method according to the twelfth embodiment of this invention. FIG. 20 is a view showing the operation of the twelfth embodiment. The operation of this embodiment, which is the same as that of the tenth embodiment except that in FIG. 16, the physical information reflecting step 02205 is replaced by a physical information reflecting step 02305 and control information 04707 is added, will not be explained in detail here.

In the physical information reflecting step 02305 in FIG. 20, hierarchical circuit information with physical information 02306 is obtained. This hierarchical circuit information with physical information 02306 is saved with a name different from the hierarchical circuit information 01404. Further, reference information 02308 is provided. This reference information 02308 is information representing the correlation of the hierarchical circuit information with physical information 02306 with the control information 02207, layout information 01401 and hierarchical circuit information 01404.

In accordance with this embodiment, using the hierarchical circuit information with physical information 02306 and reference information 02308, it is possible to determine whether or not the circuit information at issue contains the physical information, and on the basis of what input information/setting information, the circuit information at issue has been created. This facilitates the management of data.

Incidentally, it is possible to limit use of the circuit information with physical information so that it is not erroneously used for layout designing.

Further, the operation of the eleventh embodiment may be based on not the operation view of FIG. 16 relative to the tenth embodiment but the operation view of FIG. 17 relative to the eleventh embodiment.

### Embodiment 13

Now referring to the drawings, an explanation will be given of a physical information extracting/reflecting method according to the thirteenth embodiment of this invention. FIG. 17 is a view showing the operation of the thirteenth embodiment. The operation of this embodiment will be explained using the same operation view as that for the eleventh embodiment. The operation not explained is the same operation of the eleventh embodiment.

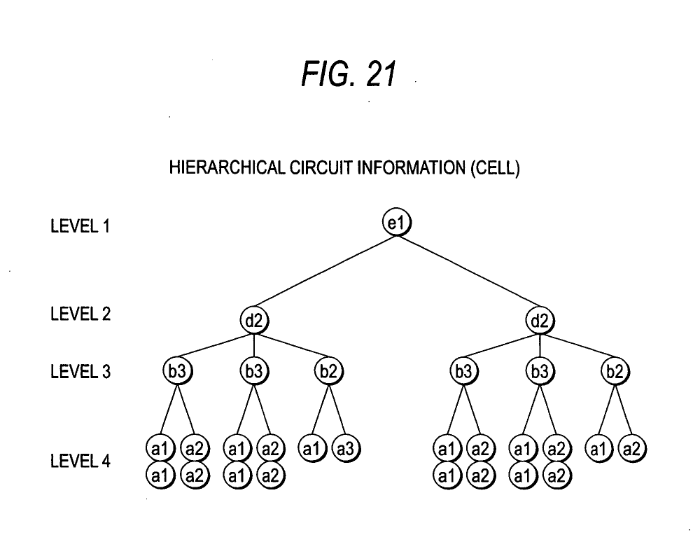

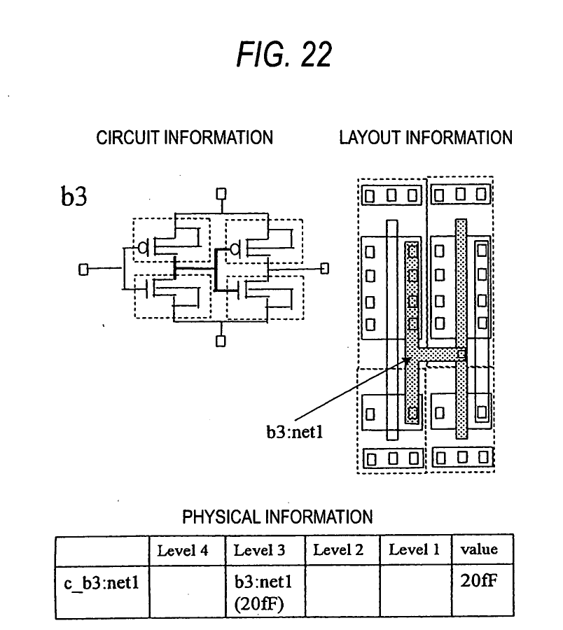

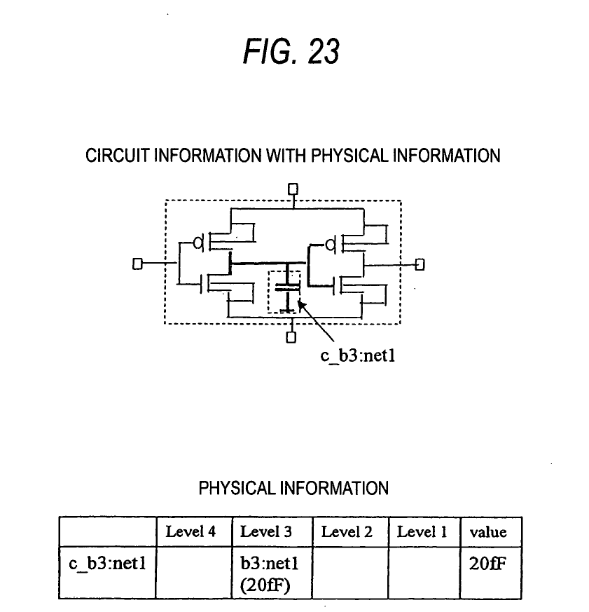

This embodiment will be explained using the hierarchical circuit information and layout information organized as shown in FIG. 21. In this embodiment, the total capacity (referred to as c_b3: net 1) of net 1 in cell b3 is noted as the physical information. FIG. 22 shows the layout information and circuit information flatly viewed from cell b3. The level to which the total capacity of net 1 in cell b3 belongs is within cell b3. Therefore, first, cell b3 is developed flatly to compute the total capacity of net 1 in the physical information extracting step 01402. The total capacity of the net 1 in Level 3 was 20 fF. FIG. 23 shows the circuit information with physical information. Since the level to which c_b1: net 1 belongs is within cell b3, a symbol of the total capacity is added. The concrete manner of providing the data of the circuit information with physical information is determined according to the physical information reflecting step of the seventh embodiment, eighth embodiment or ninth embodiment.

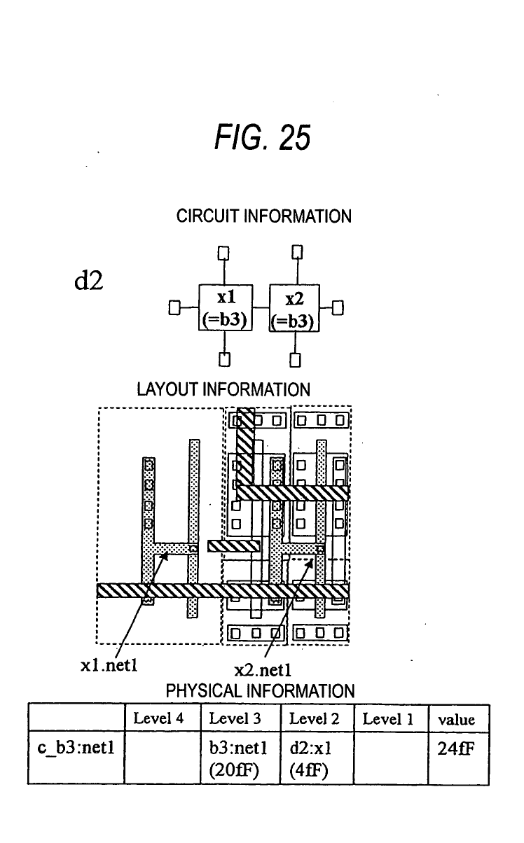

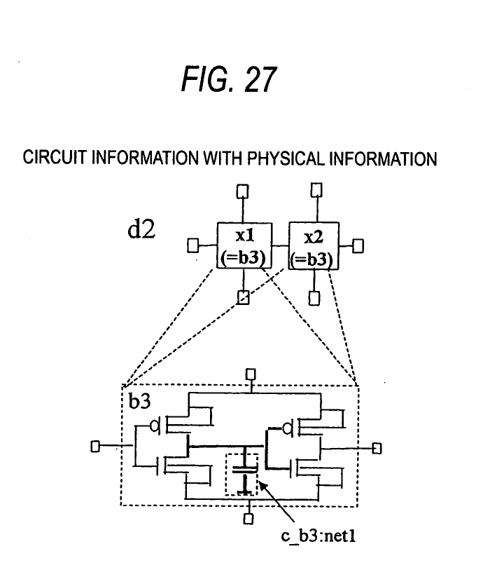

Next, cell d2 in the level above the level of cell b3 by one level is noted. Cell d2 is referred to cell b3 in instance x1 and instance x2. First, as seen from FIG. 25, a capacitor is extracted from net 1 within instance x1. Although the capacitor has been extracted from cell b3, cell d2 is developed flatly except the interior of cell b3, and the total capacity of net 1 is extracted in the physical information extracting step 01402. The extracted capacity was 4 fF. Next, the capacitor is extracted from net 1 within instance x2. Although the capacitor has been extracted from cell b3, cell d2 is developed flatly except the interior of cell b3, and the total capacity of net 1 is extracted in the physical information extracting step 01402. The extracted capacity was 6 fF. FIG. 27 shows the circuit information with physical information seen from cell d2. The concrete manner of providing the data of the circuit information with physical information is determined according to the physical information reflecting step of the seventh embodiment, eighth embodiment or ninth embodiment.

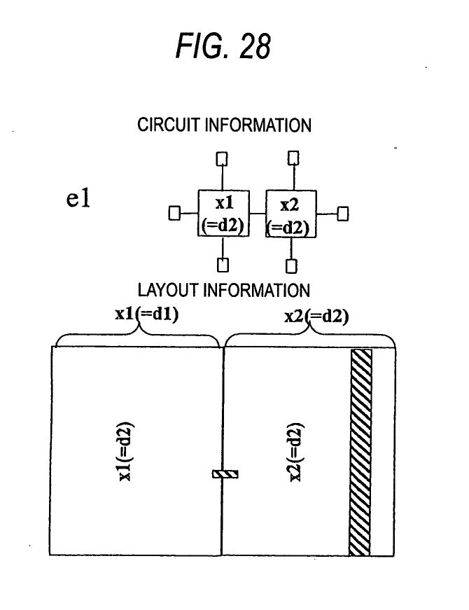

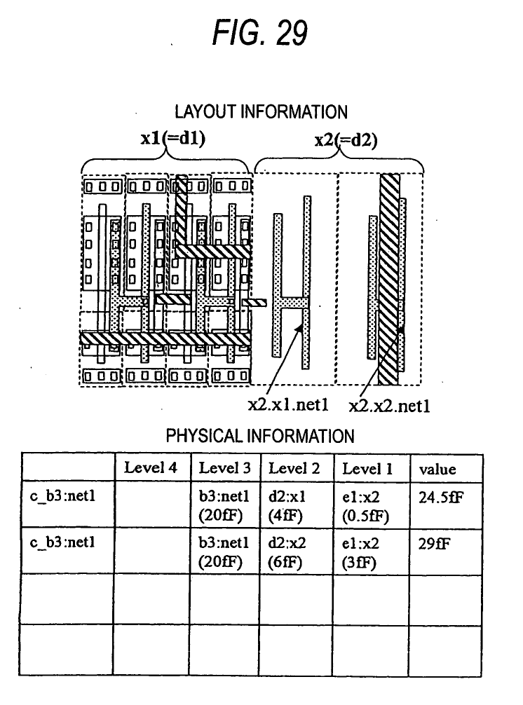

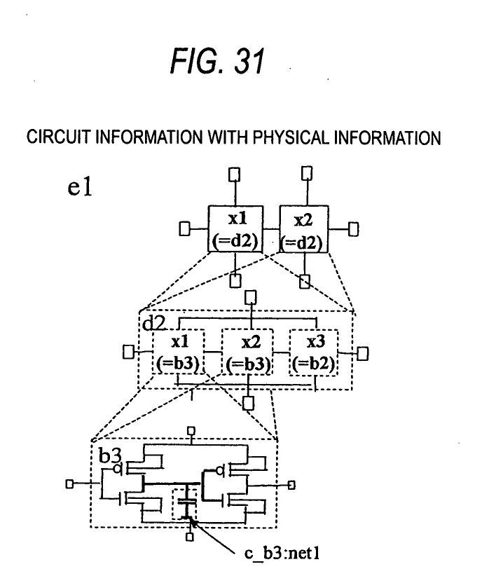

In the same process as described above, as seen from FIGS. 28, 29, 30 and 31, the physical information and circuit information with physical information can be obtained from cell e1. Likewise, The concrete manner of providing the data of the circuit information with physical information is determined according to the physical information reflecting step of the second embodiment, third embodiment or fourth embodiment.

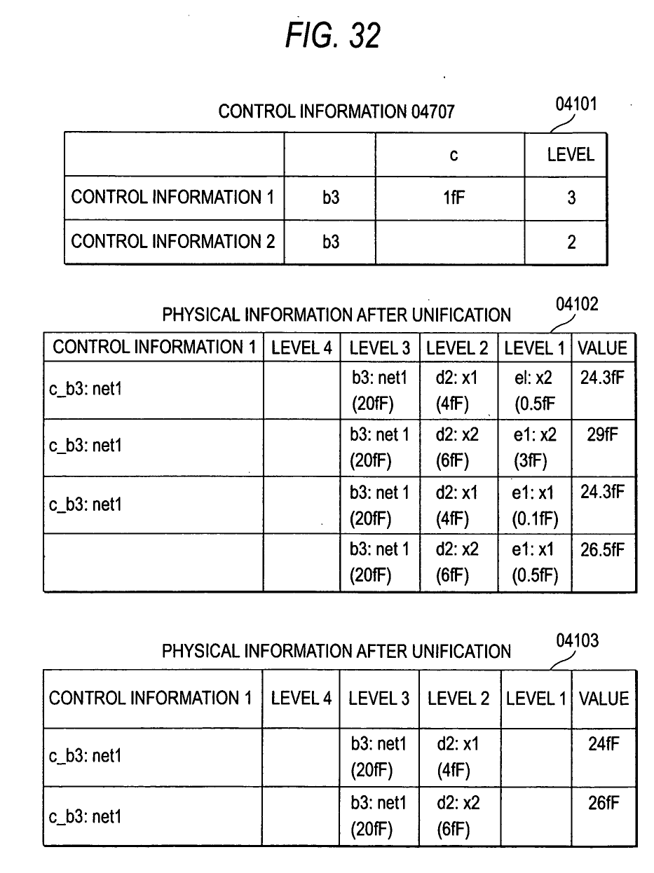

In this way, as regards the physical information having the component for each level, its accuracy varies according to the number of levels in which the physical information extracting step or physical information reflecting step is carried out. If the which the physical information extracting step or physical information reflecting step is carried out until the top level, the physical information has the highest accuracy, but it takes a long processing time. In order to obviate such an inconvenience, although in the sixth embodiment, the threshold value was set for the physical information and the circuit information, in this embodiment, the control information is used for controlling the number of levels in which the physical information extracting step and physical information reflecting step are to be carried out. Concretely, the control information (threshold value) 04101 as shown in FIG. 32 is used. If the control information 1 is used, the processing level is Level 1. However, since the total capacity 1 fF serving as the physical information is used as the threshold value for equalization, the physical information can be unified in the physical information after summarized 04102. If the control information 2 is used, since the processing level is Level 2, the physical information can be unified in the physical information after summarized 04103.

In accordance with this embodiment, the parasitic capacitor having the component for each level can be reflected on the hierarchical circuit information. So the circuit simulation with high accuracy containing the influence from the parasitic element can be carried out at a high speed, thus reducing the quantity of data.

Incidentally, as a modification of the tenth embodiment, the control information for controlling the physical information extracting step and the physical information reflecting step can be given as optimization of the data quantity, circuit simulation accuracy, circuit simulation time, processing time taken for carrying out the physical information extracting step and physical information reflecting step, or physical information accuracy.

### Embodiment 14

Now referring to the drawings, an explanation will be given of a physical information extracting/reflecting method according to the fourteenth embodiment of this invention. FIG. 17 is a view showing the operation of the fourteenth embodiment. The operation of this embodiment will be explained using the same operation view as that for the eleventh embodiment. The operation not explained is the same operation of the eleventh embodiment.

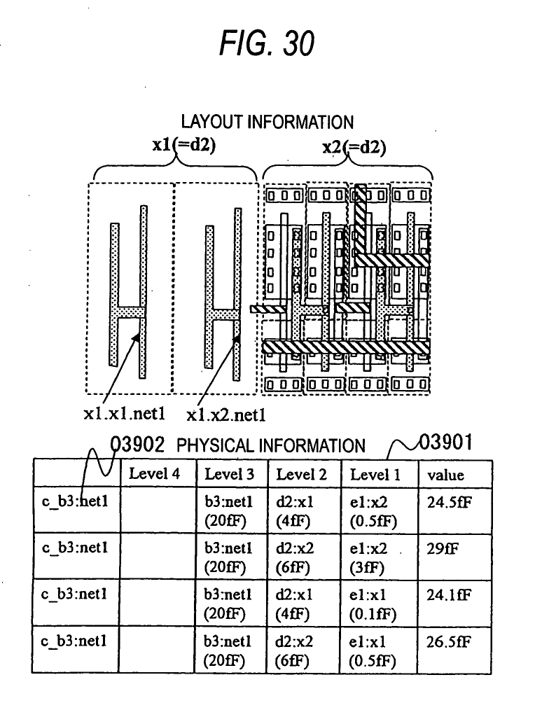

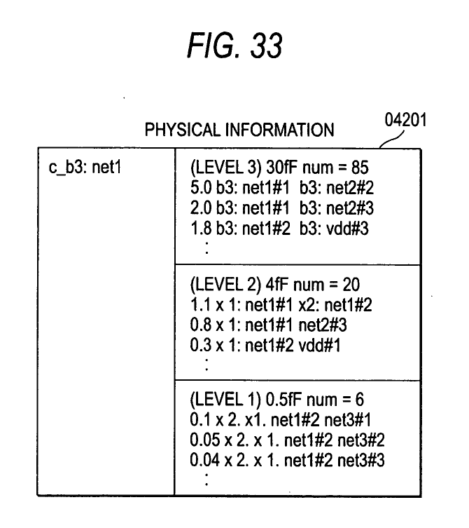

This embodiment will be explained using the hierarchical circuit information and layout information organized as shown in FIG. 21. In this embodiment, the coupling capacitor (referred to as c_b3: net 1) of net 1 in cell b3 is noted as the physical information. The physical information 03902 in FIG. 30 represents the total capacity in x2.x1.net1. The physical information 04201 in FIG. 33 which represents the coupling capacitors corresponding to the total capacity has been extracted in the physical information extracting step 01402. On the basis of the physical information 04201, in Level 3, the number of coupling capacitors is 85 and the total capacity is 20 fF. Now, the one terminal of the coupling capacitor in Level 3 is connected to net 1 and the other terminal is located in cell b3. In Level 2, the number of coupling capacitors is 20, and the total capacity is 4 fF. Now, the one terminal of the coupling capacitor in Level 2 is connected to x1.net 1 and the other terminal is located in cell d2 except instance d2.x1. In Level 1, the number of coupling capacitors is 6, and the total capacity is 0.5 fF. Now, the one terminal of the coupling capacitor in Level 1 is connected to x2.x1.net 1 and the other terminal is located in cell e1 except instance e1:x2.x1.

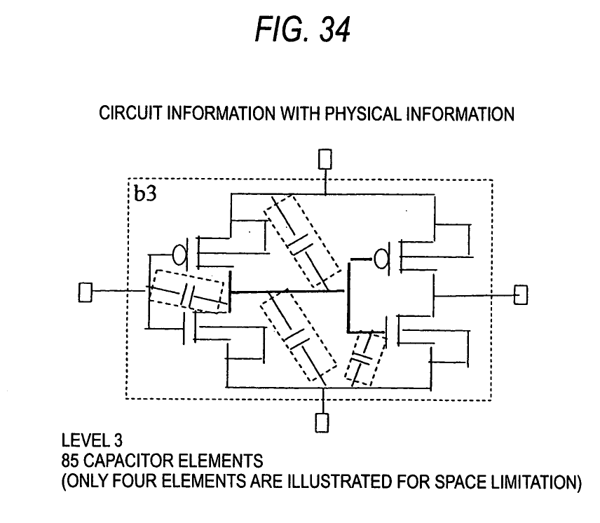

Since the coupling capacitors in Level 3 belong to cell b3, the physical information reflecting step 01405 provides the circuit information with physical information in which 85 capacitor symbols are added in cell b3 as shown in FIG. 34. The concrete manner of providing the data of the circuit information with physical information is determined according to the physical information reflecting step of the second embodiment, third embodiment or fourth embodiment.

Since the coupling capacitors in Level 2 belong to cell d2, symbols are added in cell d2 (not shown). On the other hand, since the coupling capacitors in Level 2 has 20 (twenty) connections with instance d2:x1(=b3), 20 (twenty) connecting ports added for d2:x1.

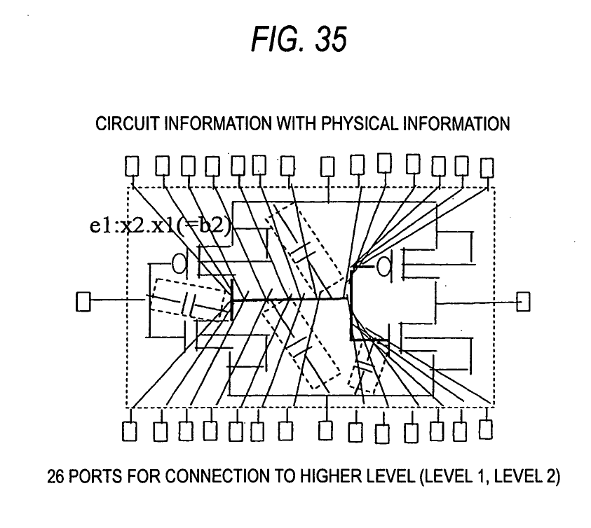

Further, since the coupling capacitors in Level 1 belong to cell e1, symbols are added in cell e1 (not shown).). On the other hand, since the coupling capacitors in Level 1 has 6 (six) connections with instance e1:x2.x1(=b3), eventually 26 connecting ports must be added for e1:x2.x1 as shown in FIG. 35.

The number of coupling capacitor in Level 3 within cell b3 does not vary for each instance. Therefore, the physical information may be reflected on not each instance but cell b3. On the other hand, the number of connecting ports to the higher level from cell b3 varies for each instance. In this embodiment, e1:x1.x2 has 26 connecting ports. However, it is supposed that e1:x1.x1 (=b3), e1:x1.x2 (=b3) and e1:x2.x2 (=b3) have different connecting ports, respectively, so that the same number of symbols can not be adopted.

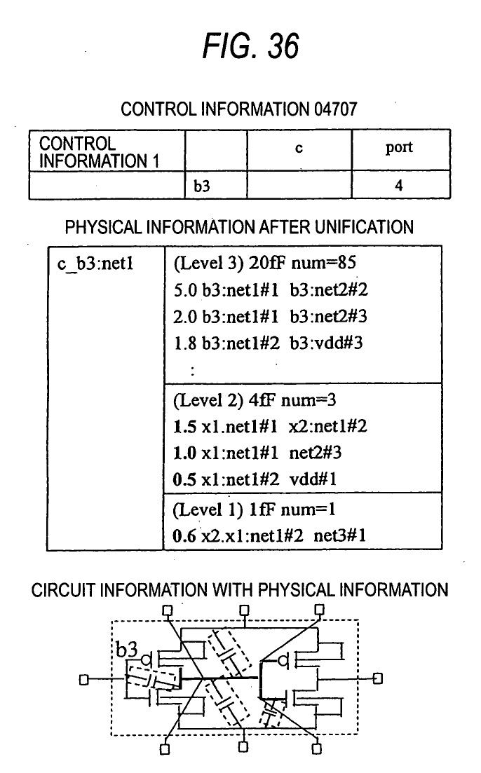

In order to obviate such an inconvenience, in the eleventh embodiment, the threshold value was set for the physical information and circuit information. On the other hand, in this embodiment, further the number of connecting ports with another level may be defined as control information 04707. Concretely, as shown in FIG. 36, if the number of connecting ports is set at 4, the number of coupling capacitors in Level 2 and Level 1 is unified in 4, and the number of connecting ports is also unified in 4. In this way, the coupling capacitors in cell b3 and those in the level higher than cell b3 can be reflected on the hierarchical circuit information.

In accordance with this embodiment, the parasitic coupling capacitor connecting the levels to each other can be reflected on the hierarchical circuit information. Thus, the circuit simulation with high accuracy containing the influence from the parasitic coupling element can be carried out at a high speed, thus reducing the quantity of data.

### Embodiment 15

Now referring to the drawings, an explanation will be given of a physical information extracting/reflecting method according to the thirteenth embodiment of this invention. FIG. 17 is a view showing the operation of the fifteenth embodiment. This embodiment is characterized in that control information 02404 is given as the threshold value explained in the eleventh embodiment, control of the number of levels explained in the thirteenth embodiment, control of connecting points between the level at issue and another level explained in the fourteenth embodiment, and the combination of them; and an optimizing step 02402 of optimizing circuit information with physical information 02401 is carried out, thereby providing circuit information with physical information after optimized which is the optimized circuit information with physical information. The contents of the optimizing step 02402 have been explained in the eleventh embodiment, thirteenth embodiment and fourteenth embodiment.

Incidentally, according to the contents of optimization, optimization of the net list with physical information which has been obtained by the conventional physical information extracting technique (LPE) can be carried out.

In accordance with this embodiment, by optimizing the circuit information with the physical information, high speed of the circuit simulation and reduction in the quantity of data can be realized.

In accordance with the method of this invention, by reflecting various kinds of physical information existing on a layout on hierarchically organized circuit information while maintaining the accuracy of the physical information, high speed of circuit simulation reflecting the physical information thereon and reduction in a quantity of data can be realized. Therefore, this invention can be applied to manufacture of a large scale circuit module.

What is claimed is:

1. A physical information extracting/reflecting method comprising:
a physical information extracting step of extracting physical information from layout information; and
a physical information reflecting step of reflecting the physical information on hierarchically organized circuit information, thereby providing the hierarchical circuit information with the physical information.

2. The physical information extracting/reflecting method according to claim 1, wherein
the layout information is hierarchically organized layout information; and
the physical information extracting step includes a step of extracting the physical information by flattering a lower level of a part or entirety of the hierarchically organized layout information.

3. The physical information extracting/reflecting method according to claim 1, wherein
the layout information contains a portion of layout corresponding to the hierarchically organized circuit information which is not hierarchically organized.

4. The physical information extracting/reflecting method according to claim 1, wherein the physical information extracting step includes a step of extracting the physical information having information on a level and a component for each level.

5. The physical information extracting/reflecting method according to claim 1, wherein the physical information extracting step includes a step of extracting the physical information having information on a level at issue, connecting information between levels and the component for each level.

6. The physical information extracting/reflecting method according to claim 1, wherein the layout information is another semiconductor manufacturing process layout information based on another semiconductor manufacturing process different from a semiconductor manufacturing process at issue; and
the physical information extracting step includes a post-processing step of extracting the physical information from another semiconductor manufacturing process layout information and correcting the physical information so that a part of the physical information not changing according to semiconductor manufacturing processes is not corrected whereas other the physical information changing according to the semiconductor manufacturing processes is corrected so as to be suited to the semiconductor manufacturing process at issue using difference information between another semiconductor manufacturing process and the semiconductor manufacturing process at issue.

7. The physical information extracting/reflecting method according to claim 1, wherein the layout information is another semiconductor manufacturing process layout information based on another semiconductor manufacturing process different from a semiconductor manufacturing process at issue; and
the physical information extracting step includes a pre-processing step of correcting another semiconductor manufacturing process layout information into the layout information for the semiconductor manufacturing process at issue through process migration so that it is suited to the semiconductor manufacturing process at issue using difference information between the semiconductor manufacturing process at issue and another semiconductor manufacturing process.

8. The physical information extracting/reflecting method according to claim 1, wherein the layout information is another layout information different from the layout information at issue; and
the physical information extracting step includes a post-processing step of extracting the physical information from another layout information and correcting the physical information different from that for the layout information at issue so that it is suited to the layout information at issue using difference information between the layout information at issue and another layout information.

9. The physical information extracting/reflecting method according to claim 1, wherein the layout information is another layout information different from the layout information at issue; and
the physical information extracting step includes a pre-processing step of correcting another layout information so that it is suited to the layout information at issue using difference information between the layout information at issue and another layout information.

10. The physical information extracting/reflecting method according to claim 1, wherein the physical information reflecting step includes a step of reflecting the physical information on elements included in the circuit information.

11. The physical information extracting/reflecting method according to claim 1, wherein the physical information reflecting step includes a step of adding additional elements to the circuit information.

12. The physical information extracting/reflecting method according to claim 1, wherein the physical information reflecting step includes a step of reflecting the physical information on the hierarchically organized circuit information using algebras.

13. The physical information extracting/reflecting method according to claim 1, wherein the physical information reflecting step includes a step of reflecting the physical information on the circuit information in different levels using algebras.

14. The physical information extracting/reflecting method according to claim 1, wherein the physical information reflecting step includes a step of reflecting the physical information on the hierarchically organized information by reflecting the physical information on netlist creating information.

15. The physical information extracting/reflecting method according to claim 1, wherein the physical information reflecting step includes a step of reflecting the physical information on the hierarchically organized information by creating cells.

16. The physical information extracting/reflecting method according to claim 1, further comprising the step of manually or automatically selecting an optimum physical information reflecting step on the basis of control information for optimizing the processing time for circuit simulation.

17. The physical information extracting/reflecting method according to claim 1, further comprising the step of manually or automatically selecting an optimum physical information reflecting step on the basis of control information for optimizing a quantity of data.

18. The physical information extracting/reflecting method according to claim 1, wherein the physical information reflecting step includes a step of reflecting at least two items of layout information corresponding to the circuit information in a single level on the circuit information in the single level.

19. The physical information extracting/reflecting method according to claim 1, wherein the physical information reflecting step includes a step of reflecting the physical information extracted for a common layout portion from at least two items of layout information corresponding to the circuit information in a single level and the physical information extracted for the other portion than the common layout portion on the circuit information in the single level.

20. The physical information extracting/reflecting method according to claim 1, wherein the physical information reflecting step includes a step of setting a threshold value as control information for controlling unification, summarizing various items of physical information in the same physical information using the threshold value if they are not larger than or smaller than the threshold value and reflecting the same physical information on the hierarchically organized circuit information.

21. The physical information extracting/reflecting method according to claim 20, wherein the threshold value is set for each level, and which of an upper level and an lower level should be given priority is set.

22. The physical information extracting/reflecting method according to claim 1, wherein the physical information reflecting step is an individual-level physical information reflecting step of reflecting the physical information having the component for each level on the hierarchical organized circuit information as a level parameter.

23. The physical information extracting/reflecting method according to claim 1, wherein the individual-level physical information reflecting step employs control information for controlling the number of levels.

24. The physical information extracting/reflecting method according to claim 23, wherein the control information for controlling the number of levels contains the control information for each cell.

25. The physical information extracting/reflecting method according to claim 23, wherein the control information for controlling the number of levels contains the control information for each instance.

26. The physical information extracting/reflecting method according to claim 23, wherein the control information for controlling the number of levels contains the control information for each net.

27. The physical information extracting/reflecting method according to claim 23, wherein the control information for controlling the number of levels contains the control information for each item of physical information.

28. The physical information extracting/reflecting method according to claim 23, wherein the control information for controlling the number of levels contains the control information set on the basis of an evaluation equation.

29. The physical information extracting/reflecting method according to claim 1, wherein the individual-level physical information reflecting step employs control information for controlling the number of connecting points between a level at issue and another level.

30. The physical information extracting/reflecting method according to claim 1, wherein the physical information reflecting step includes a physical information changing step of changing another physical information according to the physical information at issue and reflecting the changed physical information on the circuit information.

31. A hierarchical data with the physical information created by the physical information extracting/reflecting method according to claim 1.

32. A circuit designing method using the hierarchical data with the physical information created by the physical information extracting/reflecting method according to claim 1.

33. The physical information extracting/reflecting method according to claim 1, further comprising
an LSI producing step reflecting the physical information on a mask wafer and on a LSI chip.
